(19) United States
(12) Patent Application Publication
(10) Pub. No.: US 2017/0374359 A1
(43) Pub. Date: Dec. 28, 2017

(54) IMAGE PROVIDING SYSTEM

(71) Applicant: FOVE, INC., San Mateo, CA (US)

(72) Inventors: Shinji Taniguchi, Tokyo (JP); Yamato Kaneko, Tokyo (JP)

(21) Appl. No.: 15/608,511

(22) Filed: May 30, 2017

(30) Foreign Application Priority Data
May 31, 2016 (JP) 2016-109082
Sep. 12, 2016 (JP) 2016-177545

(51) Int. Cl. H04N 13/04; H04N 21/414; G02B 27/01; H04N 21/637; H04N 21/61

(52) U.S. Cl. CPC H04N 13/0484; H04N 21/637; H04N 21/61; G02B 27/0172; H04N 13/044; H04N 21/41407; G02B 2027/0138

(57) ABSTRACT

An object is to manage a plurality of users by displaying a video on a plurality of head mounted displays. A plurality of head mounted display systems are connected to a server, the server including a first communication control unit transmitting image data to the connected head mounted display systems and a generation unit generating new image data according to information relating to visual lines of users transmitted from the head mounted display systems in accordance with the image data and outputting the generated new image data to the first communication control unit, and each of the head mounted display systems including: a display unit displaying the image data supplied from the server; a detection unit detecting a visual line of a user viewing the image data displayed on the display unit; and a second communication control unit transmitting information relating to the visual line detected by the detection unit to the server.

### BACKGROUND OF THE INVENTION

### Field of the Invention

The present invention relates to an image providing system, and more particularly, to a video display technology using a head mounted display.

### Description of Related Art

Conventionally, video display systems using head mounted displays have been developed. In addition, in such head mounted displays, technologies for detecting a visual line and performing input that is based on the visual line have been developed (for example, see Japanese Unexamined Patent Application Publication No. 2012-32568)

In head mounted displays, in addition to individual viewing of a video, the same video can be simultaneously viewed by a plurality of persons.

### SUMMARY OF THE INVENTION

Meanwhile, compared to a case in which a video displayed on the same screen is simultaneously viewed by a plurality of persons, like in general movie viewing, in a case in which a video is viewed using mutually different head mounted displays by individuals, it is difficult to acquire an advantage of sharing a video with other persons. In addition, it is difficult to manage a plurality of users using the head mounted displays.

The present invention is in consideration of the problems described above, and an object thereof is to provide an image display system capable of displaying a video on a plurality of head mounted displays and managing a plurality of users.

According to one aspect of the present invention, there is provided an image providing system in which a plurality of head mounted display systems are connected to a server, the server including: a first communication control unit transmitting image data to the connected head mounted display systems; and a generation unit generating new image data according to information relating to visual lines of users transmitted from the head mounted display systems in accordance with the image data and outputting the generated new image data to the first communication control unit, and each of the head mounted display systems including: a display unit displaying the image data supplied from the server; a detection unit detecting a visual line of a user viewing the image data displayed on the display unit; and a second communication control unit transmitting information relating to the visual line detected by the detection unit to the server.

The generation unit may generate image data including information relating to visual lines detected by the plurality of head mounted display systems in the image data, and the first communication control unit may transmit the image data including the visual lines.

At least one of the plurality of head mounted display systems may be a host system and the other head mounted display systems may be client systems, the generation unit may generate image data including information relating to visual lines detected by a plurality of the client systems in the image data, and the first communication control unit may transmit the image data including the information relating to the visual lines to the host system.

The host system may further include an input unit receiving an input of a request requesting generation of image data to which information according to a visual line included in the image data is added from a user, the second communication control unit of the host system may transmit a request signal input to the input unit to the server, and the generation unit may generate new image data according to the request signal transmitted from the host system.

The generation unit may generate new image data by adding only information relating to a visual line detected by a selected head mounted display system among the plurality of head mounted display systems.

The server may further include a classification unit classifying a plurality of users as a group of users whose positions of the visual lines in the image data satisfy a predetermined condition, and a generation unit may generate image data for each user belonging to the group classified by the classification unit.

The server may further include an extraction unit extracting users whose gazing positions in visual lines are different from a target position, and the generation unit may generate image data guiding the users extracted by the extraction unit to the target position.

A request signal may include group information relating to the group of classified users, and the generation unit may generate image data including the group information.

The request signal may include guide information guiding a visual line, and the generation unit may generate image data including the guide information.

In addition, according to one aspect of the present invention, there is provided a server that is connected to a plurality of head mounted display systems and is used for an image providing system and includes a first communication control unit transmitting image data to the connected head mounted display systems and a generation unit generating new image data according to information relating to visual lines of users transmitted from the head mounted display systems in accordance with the image data and outputting the generated new image data to the first communication control unit

In addition, according to one aspect of the present invention, there is provided an image providing method used in an image providing system in which a server and a plurality of head mounted display systems are connected and includes: transmitting image data to the connected head mounted display systems by using the server; displaying the image data supplied from the server by using the head mounted display systems; detecting a visual line of a user viewing the image data displayed on a display unit by using each of the head mounted display system; transmitting information relating to the detected visual line to the server by using each of the head mounted display systems; and generating new image data according to the information relating to the visual line of the user transmitted from each of the head mounted display systems and transmitting the generated new image data to the head mounted display systems by using the server.

In addition, according to one aspect of the present invention, there is provided an image providing program, in an image providing system in which a server and a plurality of head mounted display systems are connected, that realizes: transmitting image data to the connected head mounted display systems; and generating new image data according to information relating to the visual line of the user transmitted from each of the head mounted display systems in accordance with the image data and transmitting the generated new image data to the head mounted display systems in the server.

According to the present invention, a video is displayed on a plurality of head mounted displays, and a plurality of users can be managed.

### DETAILED DESCRIPTION OF THE INVENTION

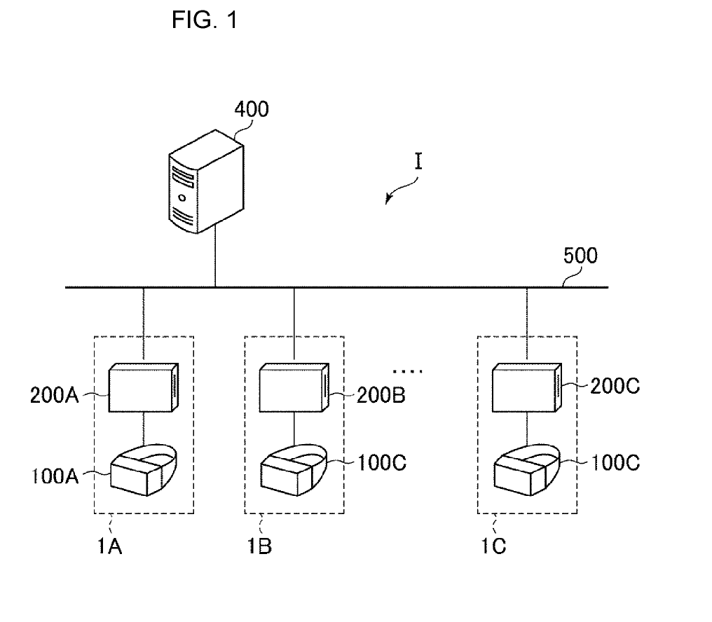

FIG. 1 is a schematic diagram illustrating an image providing system according to a first embodiment.

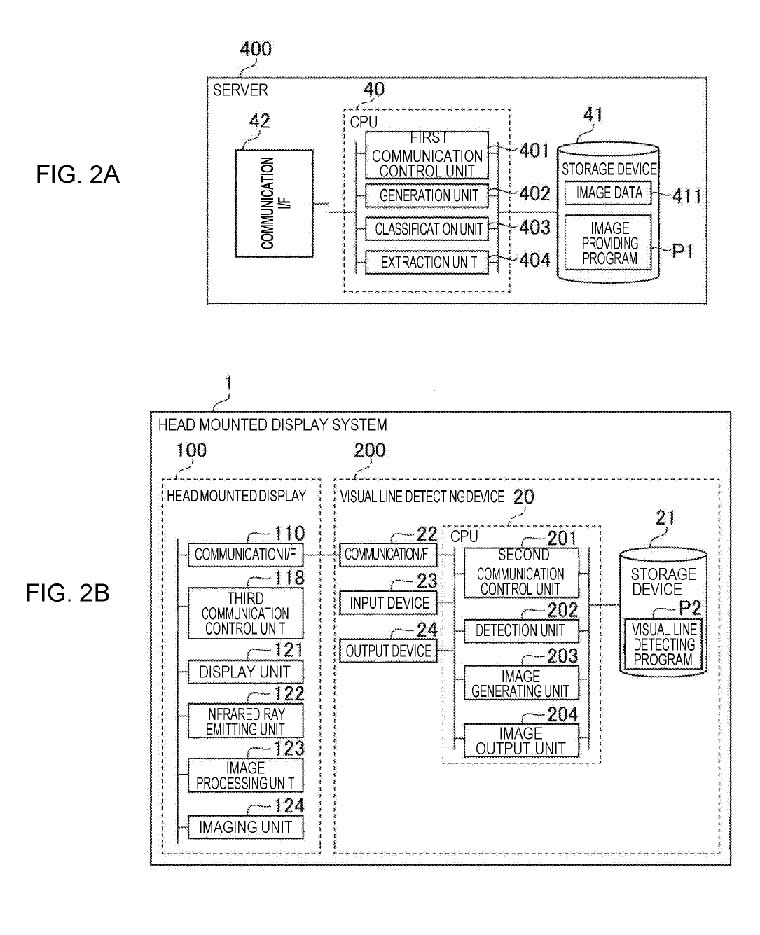

FIG. 2A is a block diagram illustrating the configuration of a server of the image providing system according to the first embodiment. FIG. 2B is a block diagram illustrating the configuration of a head mounted display system of the image providing system according to the first embodiment.

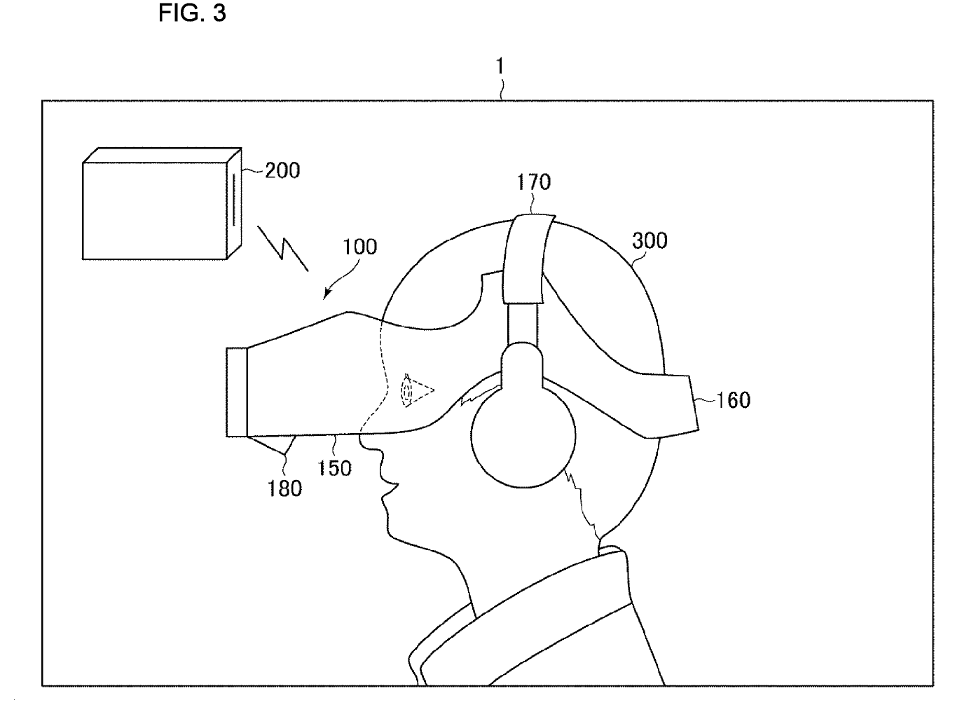

FIG. 3 is an external view illustrating the appearance of a user wearing a head mounted display according to the first embodiment.

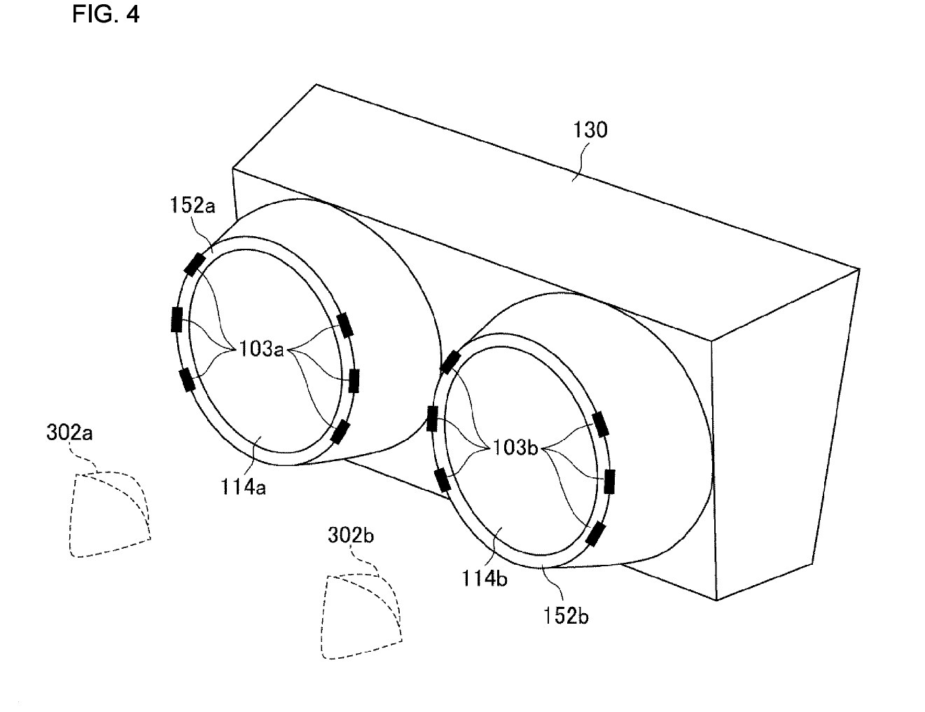

FIG. 4 is a perspective view schematically illustrating an overview of an image display system of the head mounted display according to the first embodiment.

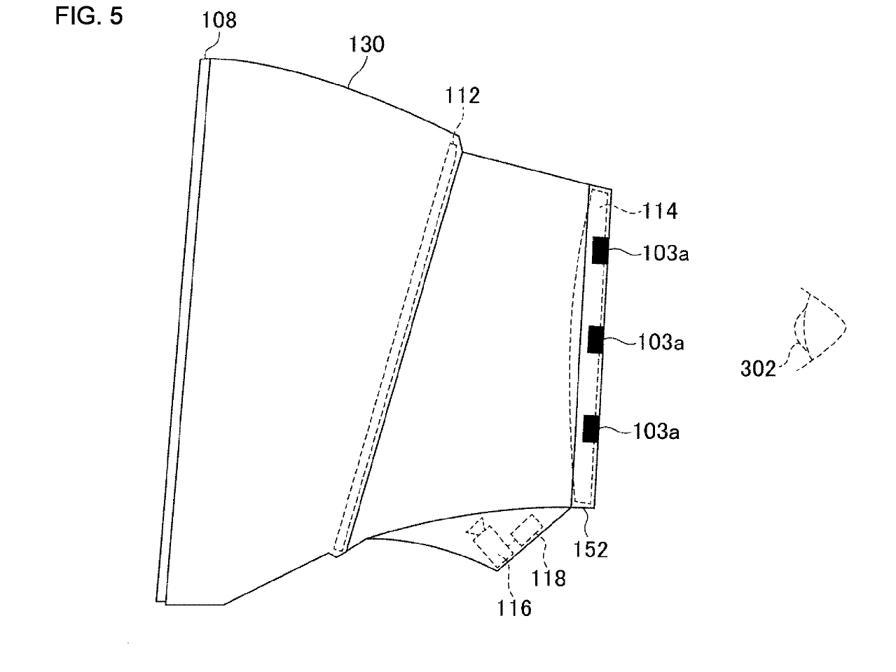

FIG. 5 is a diagram schematically illustrating the optical configuration of the image display system of the head mounted display according to the first embodiment.

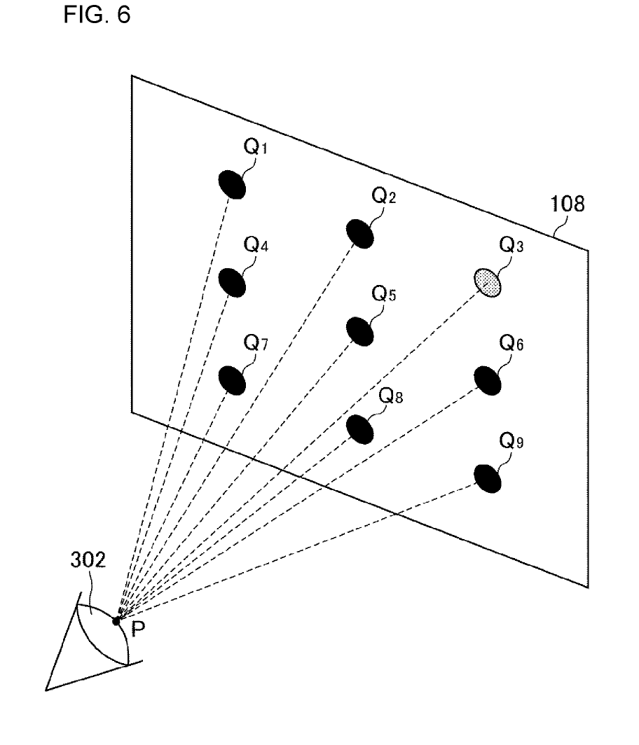

FIG. 6 is a schematic diagram illustrating the calibration for detecting the direction of a visual line in the head mounted display system according to the first embodiment.

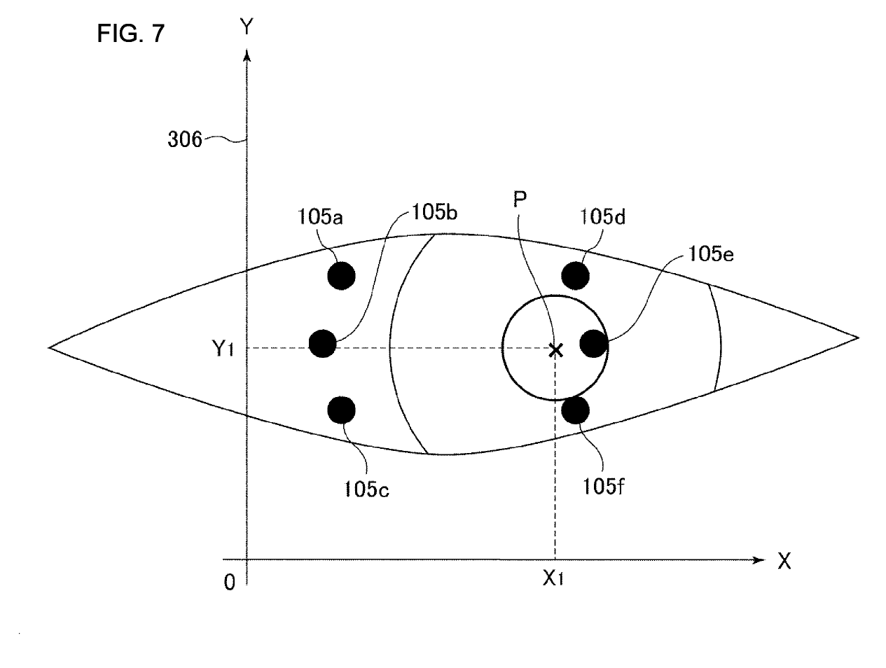

FIG. 7 is a schematic diagram illustrating the coordinates of the position of a user's cornea.

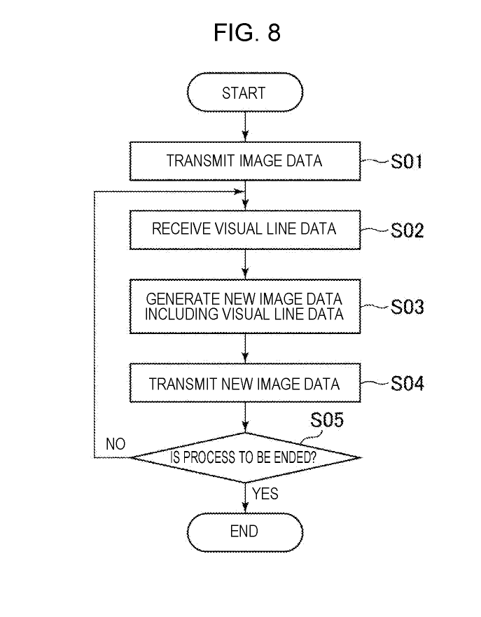

FIG. 8 is a flowchart illustrating the process performed by the server of the image providing system according to the first embodiment.

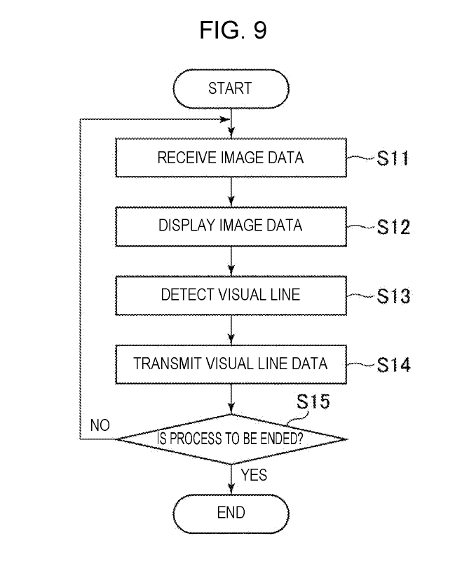

FIG. 9 is a flowchart illustrating the process performed by the head mounted display system of the image providing system according to the first embodiment.

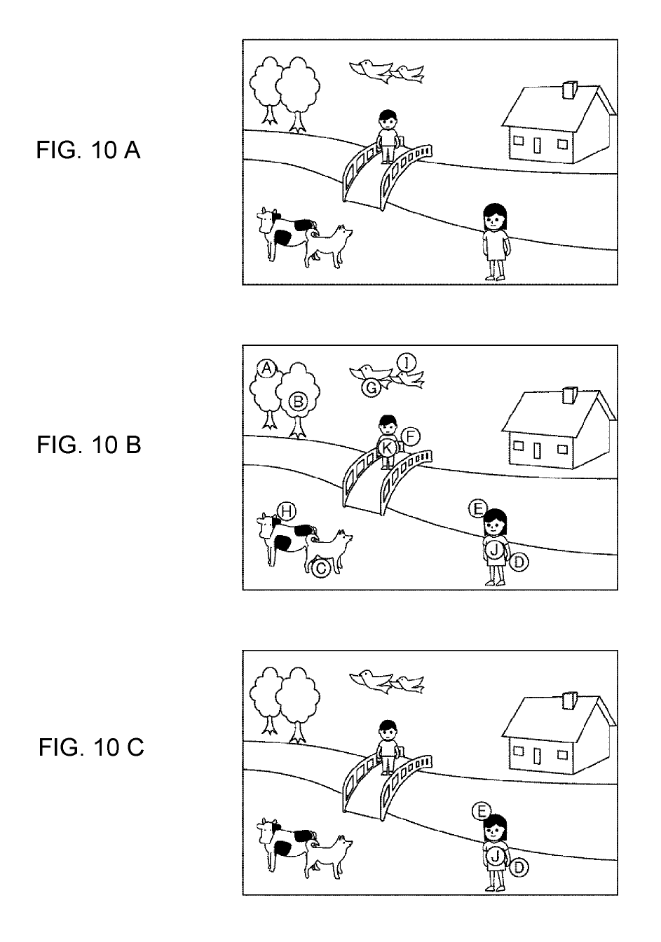

FIGS. 10A to 10C are examples of screen data displayed by the head mounted display system of the image providing system according to the first embodiment.

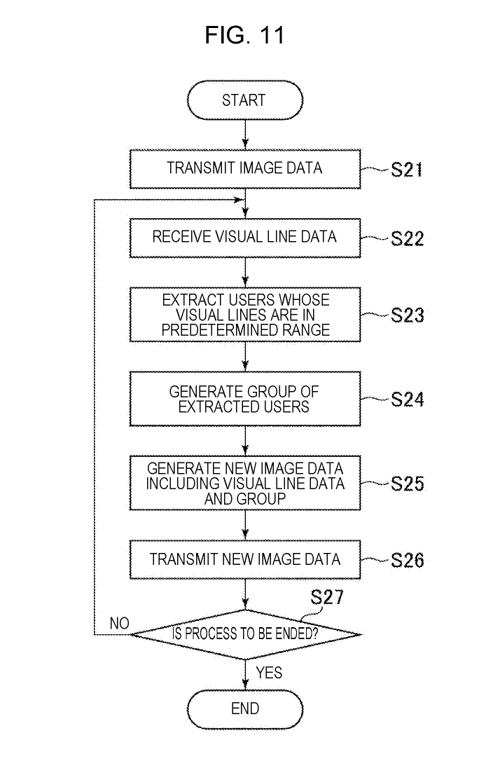

FIG. 11 is a flowchart illustrating another process performed by the server of the image providing system according to the first embodiment.

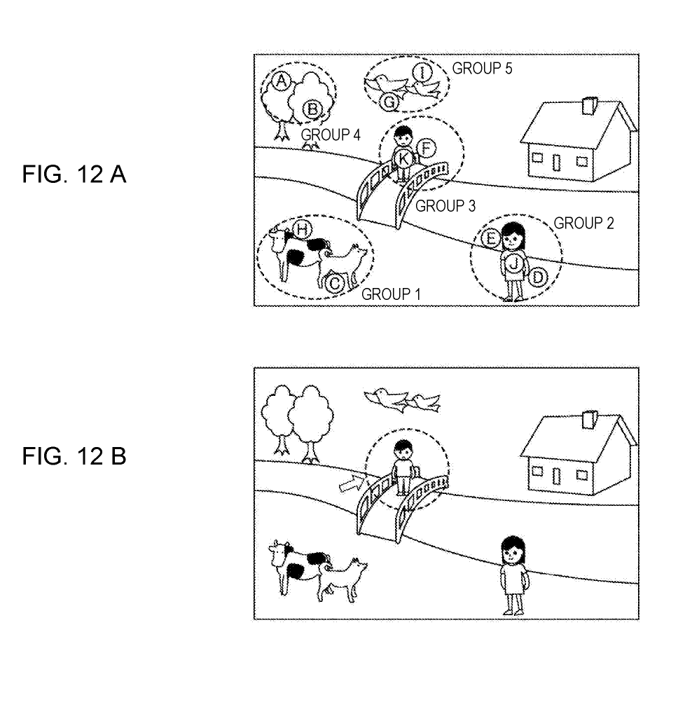

FIGS. 12A and 12B are other examples of screen data displayed by the head mounted display system of the image providing system according to the first embodiment.

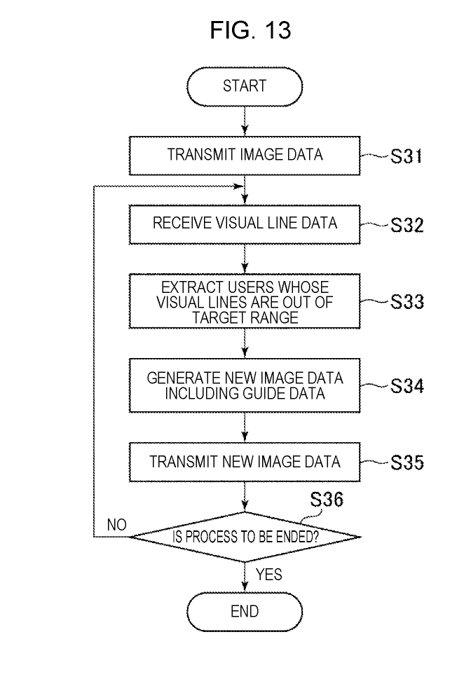

FIG. 13 is a flowchart illustrating another process performed by the server of the image providing system according to the first embodiment.

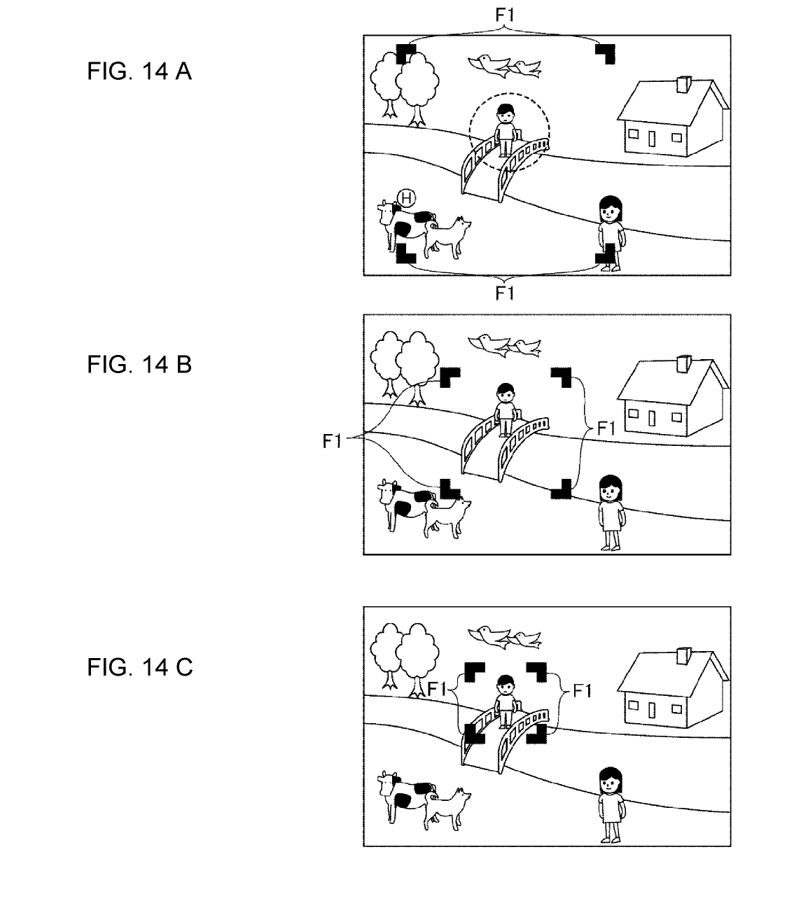

FIGS. 14A to 14C are other examples of screen data displayed by the head mounted display system of the image providing system according to the first embodiment.

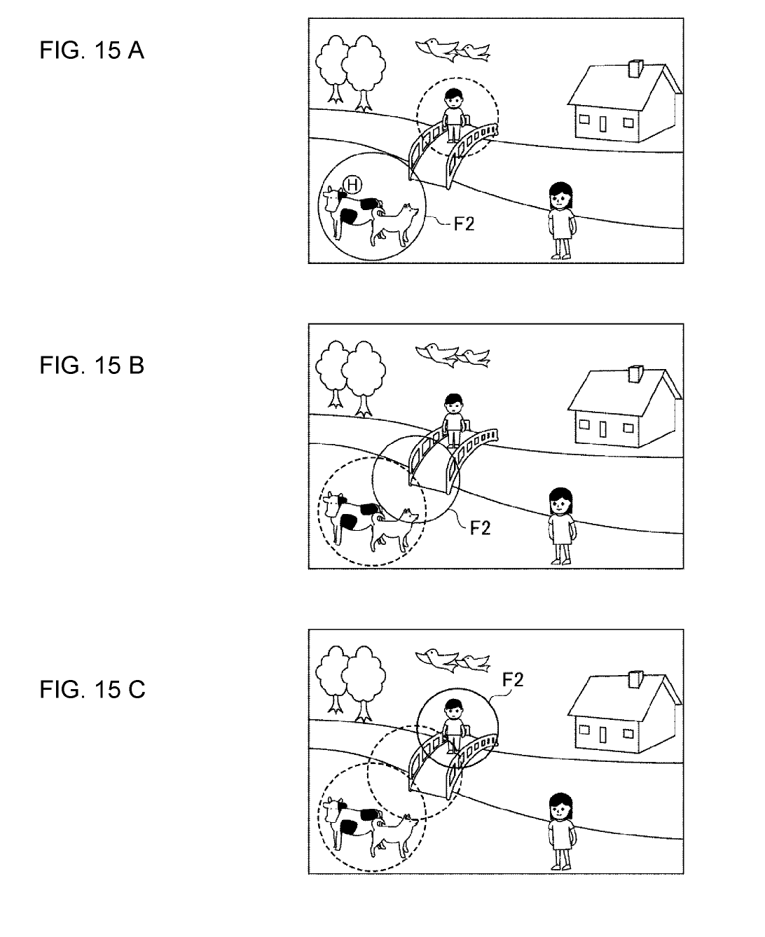

FIGS. 15A to 15C are other examples of screen data displayed by the head mounted display system of the image providing system according to the first embodiment.

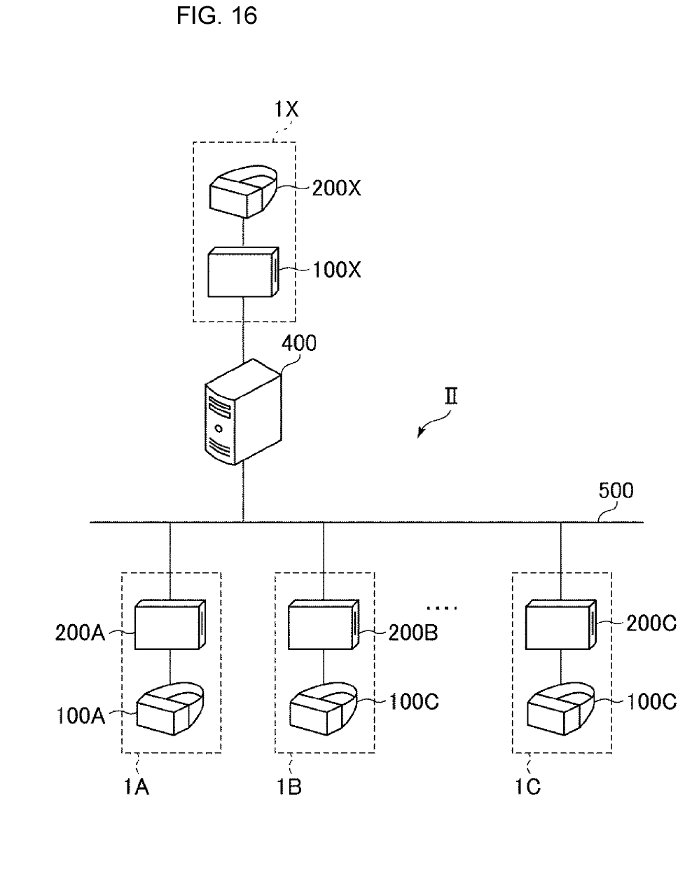

FIG. 16 is a schematic diagram illustrating an image providing system according to a second embodiment.

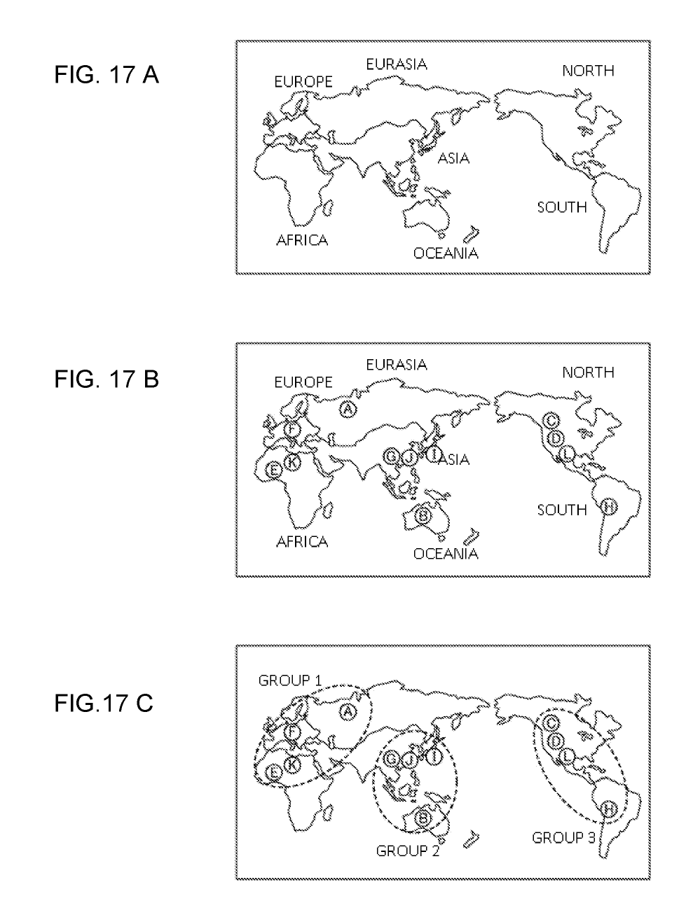

FIGS. 17A to 17C are examples of screen data displayed by a host system of the image providing system according to the second embodiment.

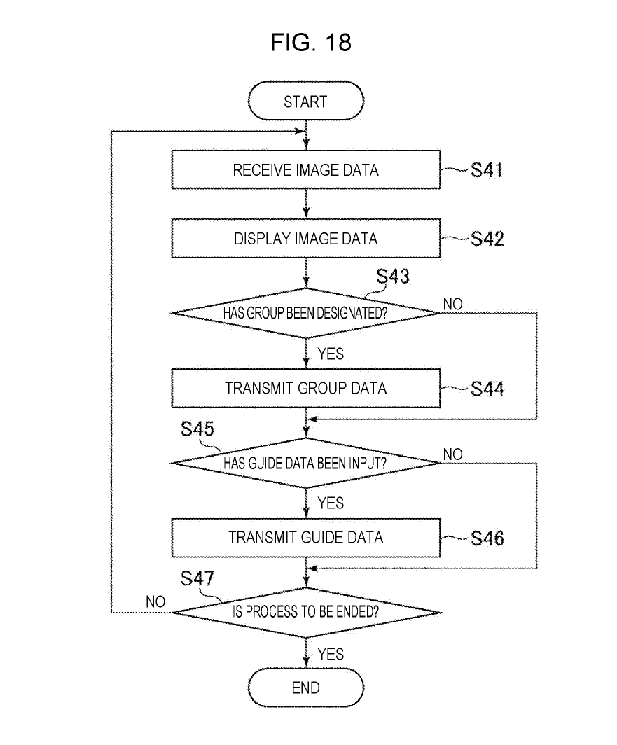

FIG. 18 is a flowchart illustrating the process performed by the host system of the image providing system according to the second embodiment.

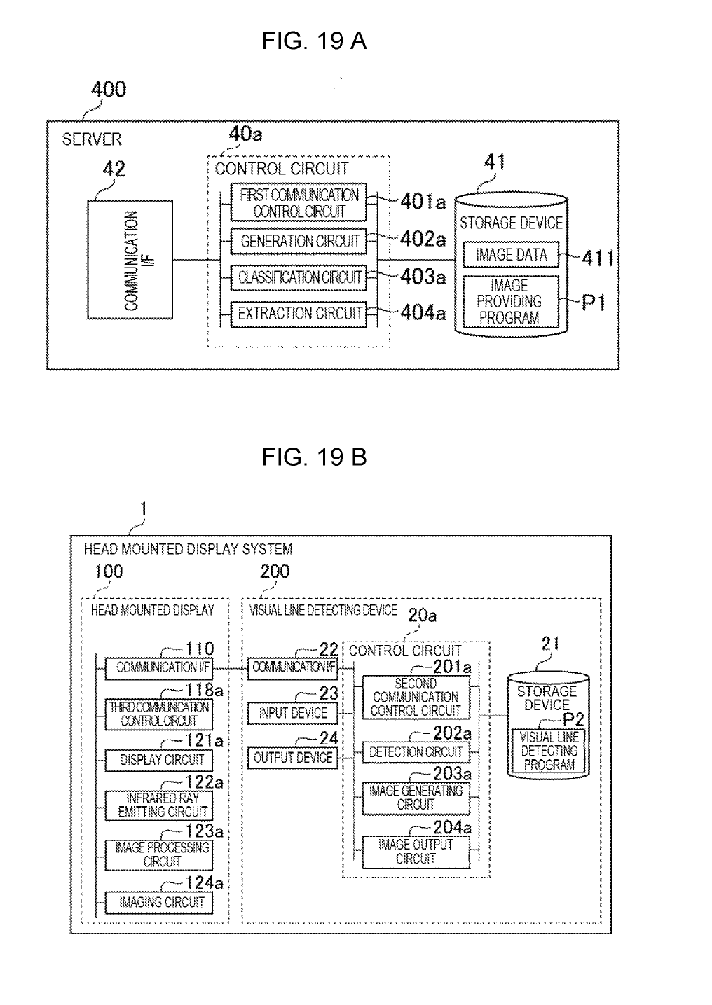

FIG. 19A is a block diagram illustrating the circuit configuration of a server. FIG. 19B is a block diagram illustrating the circuit configuration of a head mounted display system.

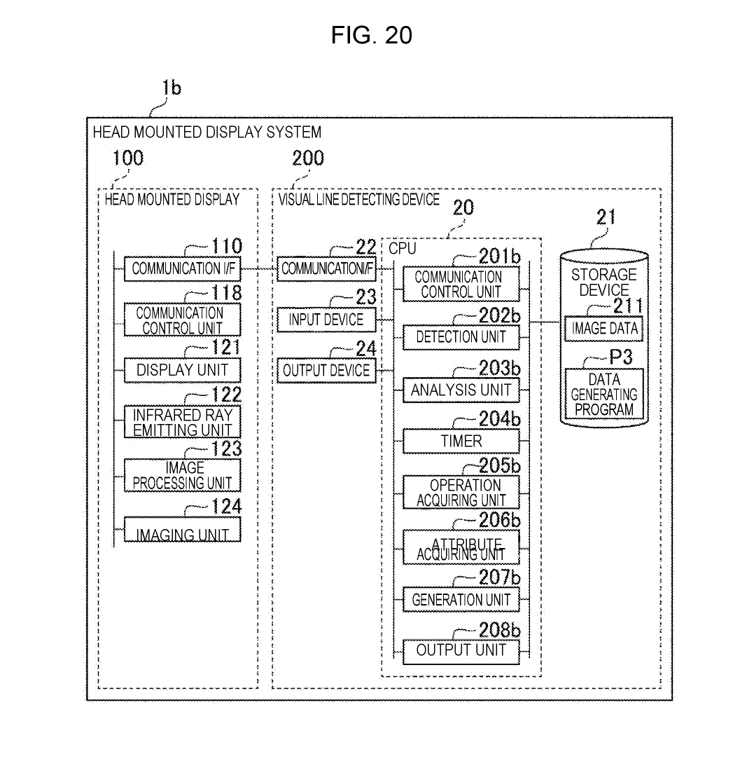

FIG. 20 is a block diagram illustrating the configuration of a head mounted display system according to a third embodiment.

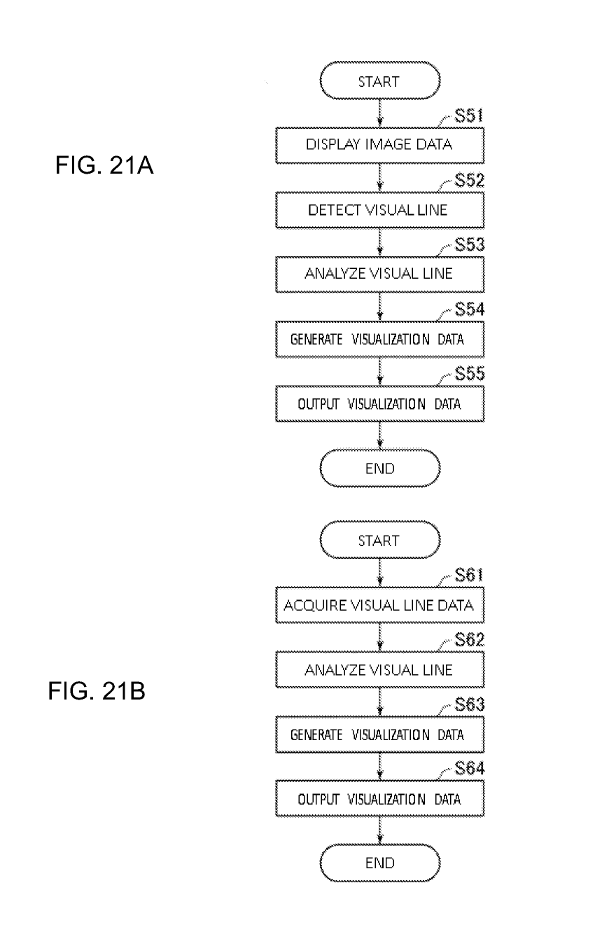

FIGS. 21A and 21B are flowcharts illustrating the process performed by the head mounted display system according to the third embodiment.

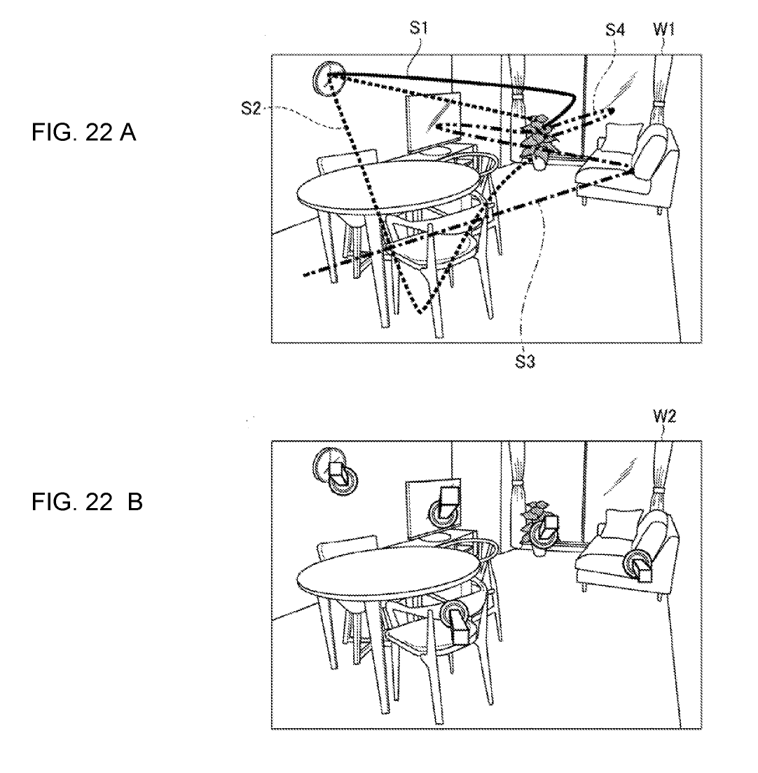

FIGS. 22A and 22B are examples of visualization displayed by the head mounted display system according to the third embodiment.

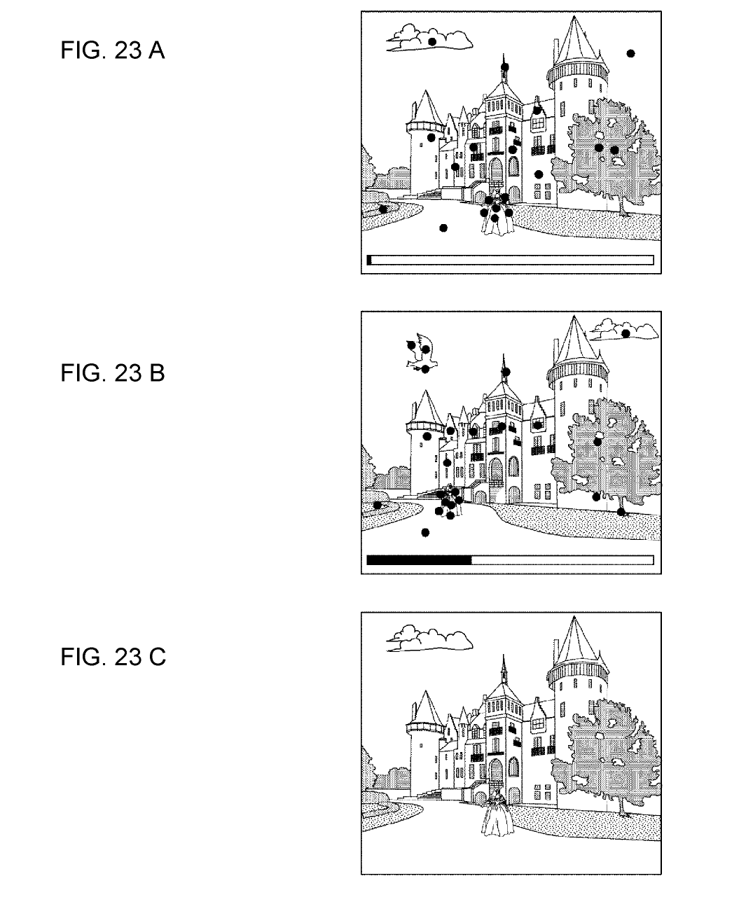

FIGS. 23A to 23C illustrate another example of visualization displayed by the head mounted display system according to the third embodiment.

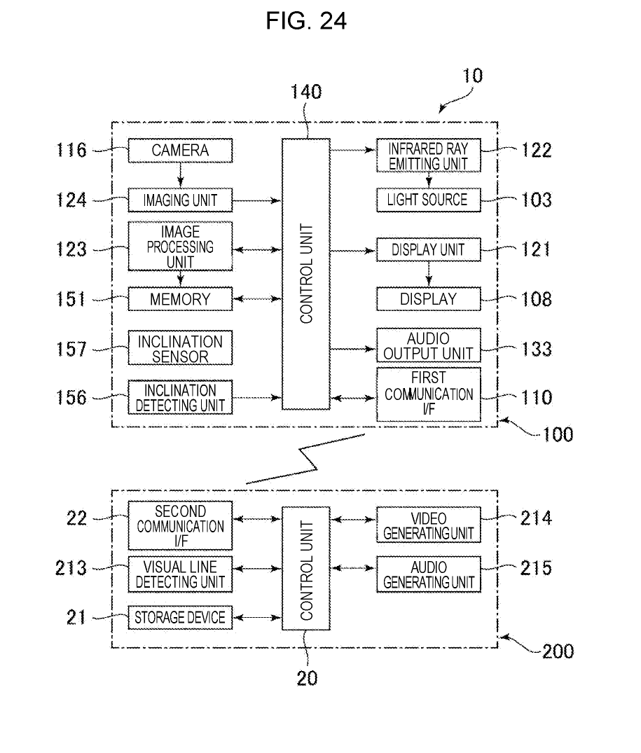

FIG. 24 illustrates a video display system according to a fourth embodiment and is a block diagram of the configuration of the video display system.

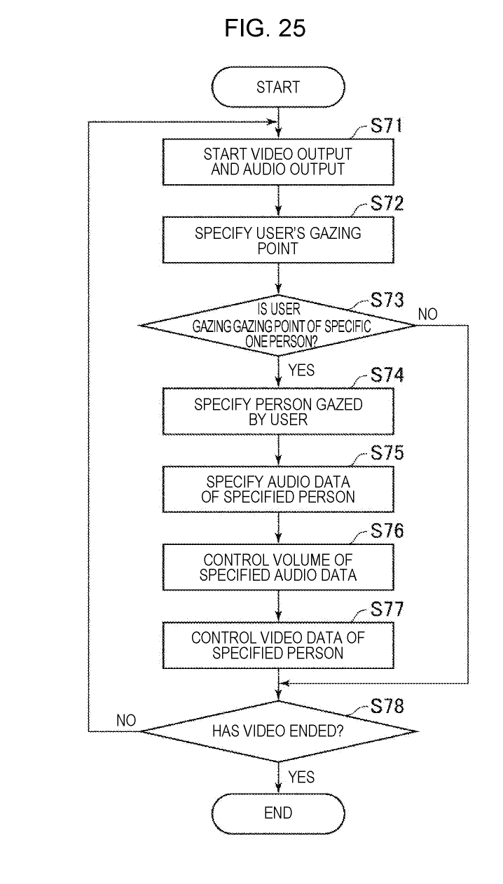

FIG. 25 illustrates the video display system according to the fourth embodiment and is a flowchart illustrating the operation of the video display system.

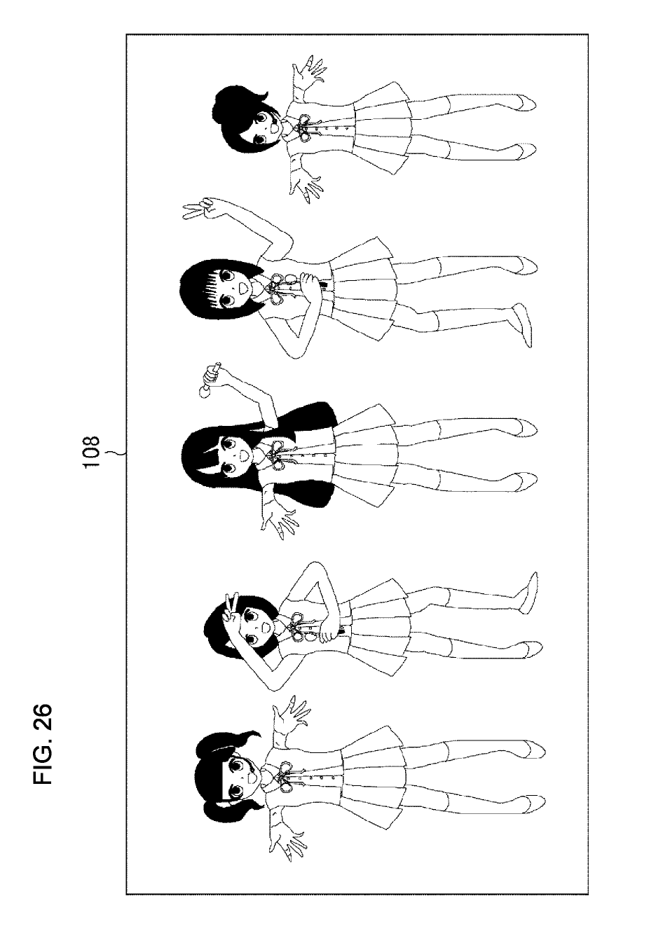

FIG. 26 illustrates the video display system according to the fourth embodiment and is an explanatory diagram of an example of video display before video processing displayed by the video display system.

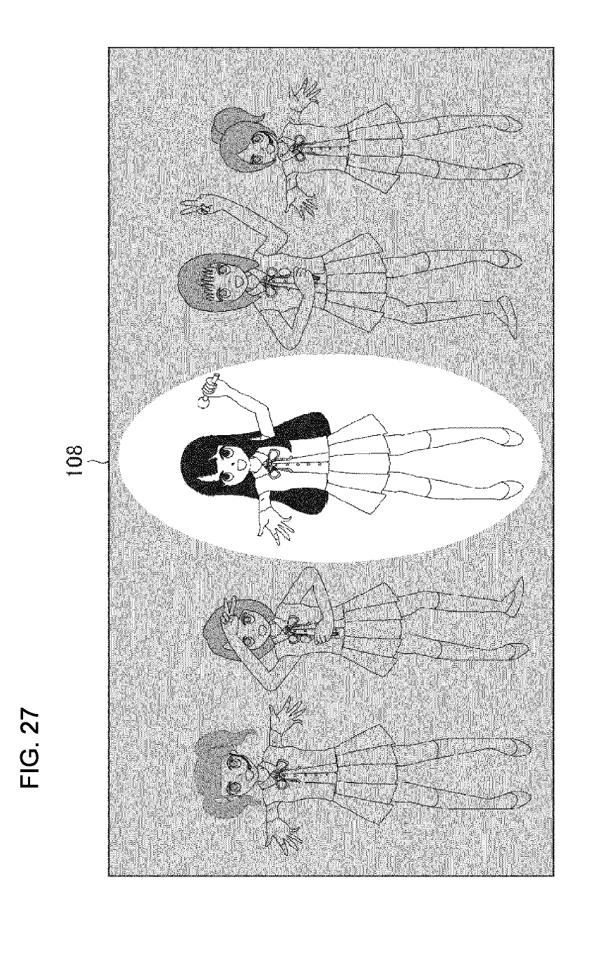

FIG. 27 illustrates the video display system according to the fourth embodiment and is an explanatory diagram of an example of video display of a video processing state displayed by the video display system.

### DETAILED DESCRIPTION OF THE INVENTION

An image providing system, a server, an image providing method, and an image providing program according to the present invention manage images provided for a plurality of head mounted displays. Hereinafter, embodiments of the present invention will be described with reference to the drawings. In description presented below, the same reference numeral is assigned to the same configuration, and duplicate description thereof will not be presented.

### First Embodiment

As illustrated in FIG. 1, in an image providing system I according to a first embodiment, a server 400 and a plurality of head mounted display systems 1 (1A to 1C) are connected through a network 500.

### <<Server>>

The server 400, as illustrated in FIG. 2A, is an information processing apparatus including a central processing unit (CPU) 40, a storage device 41, a communication interface (communication I/F) 42, and the like. The storage device 41 of the server 400 stores image data dl and an image providing program P1. This server 400 provides the image data dl for a head mounted display 100. At this time, by executing the image providing program P1, the CPU 40 performs a process as a first communication control unit 401, a generation unit 402, a classification unit 403, and an extraction unit 404.

The image data dl is not limited to still image data but may be moving image data. In description presented below, the image data dl is moving image data, and more particularly, is assumed to be video data including audio data.

The first communication control unit 401 transmits image data to the connected head mounted display system 1 through the communication I/F 42. For example, the first communication control unit 401 transmits image data 411 stored in the storage device 41. Alternatively, the first communication control unit 401 transmits image data generated by the generation unit 402.

The generation unit 402 generates new image data in accordance with a user's visual line transmitted from the head mounted display system 1 in accordance with image data transmitted by the first communication control unit 401 and outputs the generated new image data to the first communication control unit 401.

For example, the generation unit 402 adds an image that is based on visual line data received from a plurality of the head mounted display systems 1 to the image data 411 stored in the storage device 41, thereby generating new image data. When the visual line data is added, the generation unit 402 may generate new image data by adding all the visual line data received from the head mounted display systems 1. Alternatively, the generation unit 402 may generate new image data by adding only visual line data received from some of the head mounted display systems 1 that are selected.

In addition, the generation unit 402 may generate new image data by adding an image that is based on data of groups classified by the classification unit 403 to be described later to the image data 411 stored in the storage device 41. When the data of the groups is added, new image data may be generated for each group. In other words, the generation unit 402 generates image data different for each group, and each head mounted display system 1 is provided with image data generated for a group to which it belongs.

Furthermore, the generation unit 402 may generate new image data by adding an image that is based on guide data to the image data 411 stored in the storage device 41 for users classified by the extraction unit 404 to be described later. The image that is based on the guide data guides a user to a target position, in other words, a position to be viewed in the image. More specifically, the image that is based on the guide data is represented by an icon (for example, an arrow or a pop-up having “attention” written therein), a frame, or the like.

The classification unit 403 classifies users whose visual line data satisfies a predetermined condition into groups. As a classification method used by the classification unit 403, for example, the following methods may be considered.

### 1. Classification Using Visual Line Data

### (1) Group of Users Gazing at Same Object

The classification unit 403 may classify users whose visual lines are on the same object into the same group. At this time, the classification unit 403 may extract not only users whose visual lines are on a target object but also users whose visual lines are within a predetermined distance from a certain point (for example, a center point of the target object). In addition, the classification unit 403 may extract users whose visual lines are within a predetermined distance from a target object.

(2) Group of Users Whose Visual Lines are within Predetermined Range

The classification unit 403 may classify users whose visual lines are within a predetermined range into the same group. For example, the classification unit 403 may classify groups of users such as a group in which users whose visual lines are at the center of the image, a group in which users whose visual lines are on the right side of the image, and the like. In addition, at this time, the classification unit 403 may classify users whose visual lines are within a predetermined distance into the same group.

### (3) Group Classified by Clustering Process

The classification unit 403 may perform clustering of gazing coordinate positions specified from visual line information and classify users of each group.

### (4) Group of Users Whose Visual Lines are in Same Area

The classification unit 403 may divide an image into a plurality of areas in advance and classify users whose visual lines are in the same area into the same group.

### (5) Other

In addition, as described above, when user groups are classified according to visual lines, not only users whose visual lines have the relations described above at the same time but also users whose visual lines have the relations described above within a predetermined period may be classified into the same group. More specifically, in the example of (1) described above, even when the time at which a target object is viewed does not completely match, users viewing a target object for a predetermined time or more in a specific time period may be classified into the same group. For example, users gazing at a target object for at least 15 seconds or more during three minutes in which a specific image is displayed are classified into the same group.

### 2. Classification Using Visual Line Data and User's Behavior

In addition, the classification unit 403 may classify groups by using user's behaviors as illustrated below in addition to visual line data.

### (1) User's Operation

The classification unit 403 may classify users whose visual lines satisfy a predetermined condition as described above and who have performed a specific behavior at the time point into the same group. For example, users whose visual lines satisfy a predetermined condition and who have moved their heads to the right may be classified into the same group. In addition, users whose visual lines satisfy a predetermined condition and who shake their heads may be classified into the same group. In this way, users having similar feelings or ways of thinking may be classified into the same group. A user's behavior, for example, is detected by a sensor such as a gyro sensor of the head mounted display 100 and is transmitted from the head mounted display system 1 to the server 400.

### (2) Signal Input Performed by User

The classification unit 403 may classify users whose visual lines satisfy a predetermined condition as described above and who have input a predetermined operation signal at that time point into the same group. For example, when an image provided for the head mounted display system 1 is an image of a video lesson, users who have input the same answer for a question by using an operation signal may be classified into the same group. In this way, users having the same thought can be classified into a group performing group work or the like. In addition, when an image provided for the head mounted display system 1 is an image of a video game, users who have moved a character in the same direction by using an operation signal may be classified into the same group. In this way, users having the same thought can be classified into a group. The operation signal used here is input by using an input device 23 of the head mounted display system 1 and is transmitted to the server 400.

### (3) User's Behavior History

The classification unit 403 may classify users whose visual lines satisfy a predetermined condition as described above and who have performed a predetermined behavior in the past into the same group. As a behavior performed in the past, for example, participation in an event, inputting an operation signal, or the like may be considered. For example, when an image provided for the head mounted display system 1 is an image of a video lesson, users who took a specific course in the past or users who have not taken a specific course may be classified into the same group. In this way, users having a specific knowledge or users having no specific knowledge can be classified as a group performing a group work or the like. In addition, for example, in a case where an image provided for the head mounted display system 1 is an image of a video game, users who have performed the same behavior in the past may be classified into the same group. In this way, users having the same thought can be classified into a group. Here, for example, a user's behavior history is stored in the storage device of the server 400 as behavior history data. This behavior history data may be configured by an on/off flag specifying a behavior performed by a user in the past, a behavior not performed by a user in the past, or the like.

The extraction unit 404 extracts users having gazing positions different from a target position using visual lines. For example, the extraction unit 404 extracts users whose positions of the visual lines are separate from the coordinates of a target position set in advance by a predetermined distance. In addition, the extraction unit 404 may extract users by using user's behaviors in addition to visual line data. As the user's behaviors, as described above, user's operations, signal inputs performed by users, user's behavior histories, or the like.

### <<Head Mounted Display System>>

Each head mounted display system 1 (1A to 1C) includes a head mounted display 100 (100A to 100C) and a visual line detecting device 200 (200A to 200C).

As illustrated in FIG. 2B, the visual line detecting device 200 includes: a CPU 20; a storage device 21; a communication I/F 22; an input device 23; and an output device 24. In the storage device 21, a visual line detecting program P2 is stored. By executing this visual line detecting program P2, the CPU 20 performs a process as a second communication control unit 201, a detection unit 202, an image generating unit 203, and an image output unit 204. Here, while the communication I/F 22 is described to be used for communication with the server 400 through the network 500 and used for communication with the head mounted display 100, a different interface may be used for each type of communication.

The second communication control unit 201 receives image data transmitted from the server 400 through the communication I/F 22. In addition, the second communication control unit 201 transmits visual line data detected by the detection unit 202 to the server 400 through the communication I/F 22.

The detection unit 202 detects visual lines of users viewing image data displayed on the display unit 121.

The image generating unit 203, for example, using a method to be described later with reference to FIG. 6, generates an image to be displayed on the head mounted display 100.

The image output unit 204 outputs image data received from the server to the head mounted display through the communication I/F 22.

The head mounted display 100 includes a communication I/F 110, a third communication control unit 118, a display unit 121, an infrared ray emitting unit 122, an image processing unit 123, an imaging unit 124, and the like.

FIG. 4 is a block diagram illustrating the configuration of the head mounted display system 1 according to an embodiment. As illustrated in FIG. 4, the head mounted display 100 of the head mounted display system 1 includes a communication interface (I/F) 110, a third communication control unit 118, a display unit 121, an infrared ray emitting unit 122, an image processing unit 123, and an imaging unit 124.

The display unit 121 has a function of displaying image data delivered from the third communication control unit 118 on an image display device 108. The display unit 121 displays a test image as image data. In addition, the display unit 121 displays a marker image output from the image generating unit 203 at designated coordinates of the image display device 108.

The infrared ray emitting unit 122 emits infrared rays to the right eye or the left eye of the user by controlling an infrared light source 103.

The image processing unit 123 performs image processing as necessary for an image captured by the imaging unit 124 and delivers the processed image to the third communication control unit 118.

The imaging unit 124 captures an image including near infrared light reflected by each eye by using a camera 116. In addition, the imaging unit 124 captures an image including a user's eye gazing at the marker image displayed on the image display device 108. The imaging unit 124 delivers the images acquired through the capturing process to the third communication control unit 118 or the image processing unit 123.

FIG. 3 is a diagram schematically illustrating an overview of the head mounted display system 1 according to an embodiment. As illustrated in FIG. 3, the head mounted display 100 is mounted on the head of the user 300 to be used.

The visual line detecting device 200 detects the visual line direction of at least one of the right eye and the left eye of the user who wears the head mounted display 100 and specifies a focal point of the user, in other words, a portion at which the user gazes in a three-dimensional image displayed on the head mounted display. In addition, the visual line detecting device 200 functions also as a video generating device generating a video displayed by the head mounted display 100. While not particularly limited, as an example, the visual line detecting device 200 is a device capable of reproducing a video such as a stationary gaming device, a portable gaming device, a PC, a tablet, a smartphone, a phablet, a video player, or a television receiver. The visual line detecting device 200 is connected to the head mounted display 100 in a wireless or wired manner.

In the example illustrated in FIG. 3, the visual line detecting device 200 is wirelessly connected to the head mounted display 100. The wireless connection of the visual line detecting device 200 with the head mounted display 100, for example, may be realized by an existing radio communication technology such as Wi-Fi (registered trademark) or Bluetooth (registered trademark). While not particularly limited, as an example, the transmission of a video between the head mounted display 100 and the visual line detecting device 200 is performed in compliance with a standard such as Miracast (trademark), WiGig (trademark), or WHDI (trademark). In addition, any other communication technology may be used, and, for example, a sound wave communication technology or an optical transmission technology may be used.

FIG. 3 illustrates an example in which the head mounted display 100 and the visual line detecting device 200 are separate devices. However, the visual line detecting device 200 may be built in the head mounted display 100.

The head mounted display 100 includes a casing 150, a mounting fixture 160, and headphones 170. The casing 150 houses an image display system used for presenting a video to the user 300 such as an image display device and a radio transmission module not illustrated in the drawing such as a Wi-Fi module or a Bluetooth (registered trademark) module. The mounting fixture 160 is used to mount the head mounted display 100 on the head of the user 300. The mounting fixture 160, for example, may be realized by a belt, a stretchable band, or the like. When the user 300 wears the head mounted display 100 by using the mounting fixture 160, the casing 150 is arranged at a position covering the eyes of the user 300. For this reason, when the user 300 wears the head mounted display 100, the visual field of the user 300 is blocked by the casing 150.

The headphones 170 output audio of a video reproduced by the visual line detecting device 200. The headphones 170 may not be fixed to the head mounted display 100. Also in a state in which the head mounted display 100 is mounted using the mounting fixture 160, the user 300 can freely attach or detach the headphones 170. The headphones 170 are not an essential configuration.

FIG. 4 is a perspective view schematically illustrating an overview of the image display system 130 of the head mounted display 100 according to an embodiment. More specifically, FIG. 4 is a diagram illustrating an area of the casing 150 according to the embodiment that faces the corneas 302 of the user 300 when the head mounted display 100 is mounted.

As illustrated in FIG. 4, a left-eye convex lens 114a is arranged at a position facing the cornea 302a of the left eye of the user 300 when the user 300 wears the head mounted display 100. Similarly, a right-eye convex lens 114b is arranged at a position facing the cornea 302b of the right eye of the user 300 when the user 300 wears the head mounted display 100. The left-eye convex lens 114a and the right-eye convex lens 114b are respectively gripped by a left-eye lens holding part 152a and a right-eye lens holding part 152b.

Hereinafter, in the present specification, each of the left-eye convex lens 114a and the right-eye convex lens 114b will be simply referred to as a “convex lens 114” unless the convex lenses need to be particularly discriminated from each other. Similarly, each of the cornea 302a of the left eye of the user 300 and the cornea 302b of the right eye of the user 300 will be simply referred to as a “cornea 302” unless the corneas need to be particularly discriminated from each other. Each of the left-eye lens holding part 152a and the right-eye lens holding part 152b will be referred to as a “lens holding part 152” unless the lens holding parts need to be particularly discriminated from each other.

In the lens holding part 152, a plurality of infrared light sources 103 are included. In order to avoid complication, in FIG. 4, infrared light sources emitting infrared light to the cornea 302a of the left eye of the user 300 are illustrated together as infrared light sources 103a, and infrared light sources emitting infrared light to the cornea 302b of the right eye of the user 300 are illustrated together as infrared light sources 103b. Hereinafter, each of the infrared light sources 103a and the infrared light sources 103b will be referred to as an “infrared light source 103” unless the infrared light sources 103a and 103b need to be particularly discriminated from each other. In the example illustrated in FIG. 4, six infrared light sources 103a are included in the left-eye lens holding part 152a. Similarly, six infrared light sources 103b are included in the right-eye lens holding part 152b. In this way, by arranging the infrared light sources 103 in the lens holding parts 152 gripping the convex lenses 114 without directly arranging the infrared light sources 103 in the convex lenses 114, the infrared light sources 103 can be easily attached. Generally, since the lens holding parts 152 are configured using a resin or the like, processing used for attaching the infrared light sources 103 can be performed more easily for the lens holding parts 152 than for the convex lenses 114 configured using glass or the like.

As described above, the lens holding parts 152 are members gripping the convex lenses 114. Accordingly, the infrared light sources 103 included in the lens holding parts 152 are arranged on the peripheries of the convex lenses 114. Here, while the number of the infrared light sources 103 emitting infrared light to each eye is six, the number is not limited thereto. Thus, in correspondence with each eye, at least one infrared light source may be arranged, and two or more infrared light sources are preferably arranged.

FIG. 5 is a diagram schematically illustrating the optical configuration of the image display system 130 housed by the casing 150 according to an embodiment and is a diagram of a case in which the casing 150 illustrated in FIG. 5 is viewed from a side face of the left-eye side. The image display system 130 includes infrared light sources 103, an image display device 108, an optical device 112, a convex lens 114, a camera 116, and a third communication control unit 118.

The infrared light source 103 is a light source capable of emitting light of a near-infrared wavelength band (about 700 nm to 2500 nm). Generally, the infrared light is light of a wavelength band of non-visible light that cannot be observed by the naked eye of the user 300.

The image display device 108 displays an image to be presented to the user 300. The image displayed by the image display device 108 is generated by the generation unit 402 disposed inside the server 400 or the image generating unit 203 disposed inside the visual line detecting device 200. In addition, the image may be generated by the generation unit 402 and the image generating unit 203. The image display device 108, for example, may be realized by an existing liquid crystal display (LCD), organic electroluminescence display (organic EL display), or the like.

When the user 300 wears the head mounted display 100, the optical device 112 is arranged between the image display device 108 and the cornea 302 of the user 300. The optical device 112 has characteristics of transmitting visible light generated by the image display device 108 but reflecting near-infrared light. This optical device 112 has a characteristic of reflecting light of a specific frequency band and, for example, is a transparent flat plate, a hot mirror, a prism, or the like.

The convex lens 114 is arranged on the opposite side of the image display device 108 with respect to the optical device 112. In other words, when the user 300 wears the head mounted display 100, the convex lens 114 is arranged between the optical device 112 and the cornea 302 of the user 300. In other words, when the head mounted display 100 is worn by the user 300, the convex lens 114 is arranged at a position facing the cornea 302 of the user 300.

The convex lens 114 collects image display light transmitted through the optical device 112. For this reason, the convex lens 114 functions as an image enlarging unit that enlarges an image generated by the image display device 108 and presents the enlarged image to the user 300. While only one of each convex lens 114 is illustrated in FIG. 5 for the convenience of description, the convex lenses 114 may be lens groups configured by combining various lenses or a one-side convex lens of which one side has curvature and the other side has a flat face.

A plurality of infrared light sources 103 are arranged on the periphery of the convex lens 114. Each of the infrared light sources 103 emits infrared light toward the cornea 302 of the user 300.

While not illustrated in the drawing, the image display system 130 of the head mounted display 100 according to an embodiment includes two image display devices 108 and can independently generate an image to be presented to the right eye of the user 300 and an image to be presented to the left eye. For this reason, the head mounted display 100 according to an embodiment can present a right-eye parallax image and a left-eye parallax image respectively to the right eye and the left eye of the user 300. In this way, the head mounted display 100 according to an embodiment can present a stereoscopic video having a depth feeling to the user 300.

As described above, the optical device 112 transmits visible light and reflects or partially reflects near-infrared light or reflects light of a specific frequency. Accordingly, the image light emitted by the image display device 108 is transmitted through the optical device 112 and arrives at the cornea 302 of the user 300. In addition, infrared light that is emitted from the infrared light source 103 and is reflected by a reflection area disposed inside the convex lens 114 arrives at the cornea 302 of the user 300.

The infrared light arriving at the cornea 302 of the user 300 is reflected by the cornea 302 of the user 300 and travels toward the side of the convex lens 114. This infrared light is transmitted through the convex lens 114 and is reflected by the optical device 112. The camera 116 includes a filter blocking visible light and captures the near-infrared light reflected by the optical device 112. In other words, the camera 116 is a near-infrared camera that captures near-infrared light that is emitted from the infrared light source 103 and is reflected by the cornea of the eye of the user 300.

While not illustrated in the drawing, the image display system 130 of the head mounted display 100 according to an embodiment includes two cameras 116, in other words, a first imaging unit that captures an image including infrared light reflected by the right eye and a second imaging unit that captures an image including infrared light reflected by the left eye. In this way, images used for detecting the directions of the visual lines of both the right eye and the left eye of the user 300 can be acquired.

The third communication control unit 118 outputs the images captured by the cameras 116 to the visual line detecting device 200 detecting the direction of the visual line of the user 300. More specifically, the third communication control unit 118 transmits the images captured by the cameras 116 to the visual line detecting device 200 through the communication I/F 110. While the details of the detection unit 202 functioning as a visual line direction detecting unit will be described later, the detection unit 202 is realized by a video displaying program executed by a central processing unit (CPU) of the visual line detecting device 200. In addition, when the head mounted display 100 includes calculation resources such as a CPU, a memory, and the like, the CPU of the head mounted display 100 may execute a program realizing the visual line direction detecting unit.

While details will be described later, in an image captured by the camera 116, bright spots due to the near-infrared light reflected by the cornea 302 of the user 300 and an image of the eye including the cornea 302 of the user 300 observed in a near-infrared wavelength band are captured.

While the configuration for presenting an image to the left eye of the user 300 in the image display system 130 according to an embodiment has been mainly described, a configuration for presenting an image to the right eye of the user 300 is similar to that described above.

Next, detection of the direction of a visual line according to an embodiment will be described.

FIG. 6 is a schematic diagram illustrating the calibration for detecting the direction of a visual line according to an embodiment. The direction of the visual line of the user 300 is acquired by analyzing a video that is captured by the camera 116 and is output by the third communication control unit 118 to the visual line detecting device 200 using the detection unit 202 disposed inside the visual line detecting device 200.

The image generating unit 203 generates nine points (marker images) Q1 to Q9 as illustrated in FIG. 6 and displays the generated points on the image display device 108 of the head mounted display 100. The visual line detecting device 200 causes the user 300 to sequentially gaze at the points Q1 to Q9. At this time, the user 300 is required to gaze at each of the points by moving only his or her eyeballs as much as possible without moving his or her neck, and the camera 116 captures images including the cornea 302 of the user 300 when the user 300 gazes at the nine points Q1 to Q9.

FIG. 7 is a schematic diagram illustrating the coordinates of the position of the cornea 302 of the user 300. The detection unit 202 disposed inside the visual line detecting device 200 detects bright spots 105 originating from infrared light by analyzing an image captured by the camera 116. When the user 300 gazes at each of the points by only moving his or her eyeballs, it is assumed that the positions of the bright spots 105 do not move regardless of at which point the user gazes. Thus, the detection unit 202 sets a two-dimensional coordinate system 306 inside the image captured by the camera 116 based on the detected bright spots 105.

In addition, the detection unit 202, by analyzing the image captured by the camera 116, detects the center P of the cornea 302 of the user 300. This, for example, can be realized using existing image processing such as a Hough transform or an edge extraction process. In this way, the detection unit 202 can acquire the coordinates of the center P of the cornea 302 of the user 300 in the set two-dimensional coordinate system 306.

In the case illustrated in FIG. 6, in the two-dimensional coordinate system set on the display screen displayed by the image display device 108, the coordinates of the points Q1 to Q9 will be respectively denoted by Q1(x1, y1)^{T}, Q2(x2, y2)^{T}, . . . , and Q9(x9, x9)^{T}. The coordinates of each point, for example, are configured by the number of a pixel positioned at the center of the point. In addition, the centers P of the cornea 302 of the user 300 when the user 300 gazes at the points Q1 to Q9 are respectively denoted by points P1 to P9. At this time, the coordinates of the points P1 to P9 in the two-dimensional coordinate system 306 will be denoted by P1(X1, Y1)^{T}, P2(X2, Y2)^{T}, . . . , and P9(Z9, Y9)^{T}. Here, “T” represents the transposition of a vector or a matrix.

Now, a matrix M having a size of 2×2 is defined as in the following Equation (1)

$$M = ( \begin{matrix}{m}_{11} & {m}_{12} \\ {m}_{21} & {m}_{22}\end{matrix} ) \qquad ( 1 )$$

At this time, when the matrix M satisfies the following Equation (2), the matrix M is a matrix projecting in the direction of the visual line of the user 300 onto an image surface displayed by the image display device 108.

P_{N}=MQ_{N}(N=1, . . . ,9) (2)

When Equation (2) described above is written specifically, the following Equation (3) is obtained.

$$( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

When Equation (3) is transformed, the following Equation (4) is obtained.

$$( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) \\ y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} ) \qquad ( 4 )$$

Thus, the following Equation (5) is acquired.

y=Ax (5)

In Equation (5), the elements of the vector y are the coordinates of the points Q1 to Q9 displayed on the image display device 108 by the detection unit 202 and thus are known. In addition, the elements of the matrix A are the coordinates of the vertex P of the cornea 302 of the user 300 and thus can be acquired. Accordingly, the detection unit 202 can acquire the vector y and the matrix A. In addition, the vector x that is a vector acquired by aligning the elements of the transformation matrix M is unknown. Thus, a problem of estimating the matrix M is a problem of acquiring the unknown vector x when the vector y and the matrix A are known.

In Equation (5), when the number of equations (in other words, the number of points Q presented to the user 300 when the detection unit 202 performs calibration) is larger than the number of unknown quantities (in other words, the number of elements of the vector x which is “4”), an overdetermined problem is formed. In the example represented in Equation (5), since the number of equations is nine, an overdetermined problem is formed.

An error vector between the vector y and the vector Ax is set as a vector e. In other words, e=y−Ax. At this time, for the purpose of minimizing a square sum of the elements of the vector e, an optimal vector xₒₚₜ is acquired using the following Equation (6).

xₒₚₜ=(A^{T}A)⁻¹A^{T}y (6)

Here, “−1” represents an inverse matrix.

The detection unit 202 composes the matrix M represented in Equation (1) by using the elements of the acquired vector xₒₚₜ. In this way, by using the coordinates of the vertex P of the cornea 302 of the user 300 and the matrix M, the detection unit 202 can estimate a place on a moving image displayed on the image display device 108 at which the right eye of the user 300 gazes based on Equation (2). Here, the detection unit 202 further receives information of a distance between the user's eye and the image display device 108 from the head mounted display 100 and corrects the values of coordinates at which the user gazes in accordance with the information of the distance. In addition, a deviation in the estimation of a gazing position according to the distance between the user's eye and the image display device 108 may be ignored as the range of an error. In this way, the detection unit 202 can calculate a right-eye visual line vector joining a gazing point of the right eye on the image display device 108 and the vertex of the cornea of the user's right eye. Similarly, the detection unit 202 can calculate a left-eye visual line vector joining a gazing point of the left eye on the image display device 108 and the vertex of the cornea of the user's left eye. In addition, a user's gazing point on a two-dimensional plane can be specified using the visual line vector of only one eye, and by acquiring the visual line vectors of both eyes, information of the user's gazing point in the depth direction can be calculated as well. In this way, the visual line detecting device 200 can specify a user's gazing point. The method of specifying a gazing point illustrated here is an example, and thus a user's gazing point may be specified using other techniques described in this embodiment.

<<Example in which Visual Line Information of User is Displayed on Image>>

An example of a process performed when visual line information of a user is displayed on an image will be described with reference to FIGS. 8 and 9. FIG. 8 is a flowchart illustrating the process performed by the server 400.

First, the server 400 transmits image data dl stored in the storage device 41 to each head mounted display system 1 connected through the network 500 (S01).

Thereafter, the server 400 receives visual line data of users viewing the image data dl from each head mounted display system 1 (S02).

In addition, the server 400 generates new image data including the received visual line data of each head mounted display system 1 (S03).

Subsequently, the server 400 transmits the new image data to each head mounted display system 1 (S04).

Until an end request is received, the server 400 continues the process of Steps S02 to S04 (S05).

FIG. 9 is a flowchart illustrating the process performed by the head mounted display system 1. When image data is received from the server 400 (S11), the head mounted display system 1 displays the received image data (S12).

In addition, the head mounted display system 1 detects visual line data of users viewing the displayed image data (S13).

Thereafter, the head mounted display system 1 transmits the detected visual line data to the server 400 (S14).

Until an end request is received, the head mounted display system 1 repeats the process of Steps S11 to S14 (S15).

FIG. 10(a) is an example of an image that is transmitted by the server 400 in Step S01 and is displayed in the head mounted display system 1 in Step S12.

FIG. 10(b) is an example of an image including visual line data. This is image data including the visual line data generated in Step S03 in accordance with the detection of the visual line data in the head mounted display system 1 in Step S13. Here, in the example, the visual line data of users is added to the image data using identifiers A to K.

FIG. 10(c) is another example of an image including visual line data. FIG. 10(b) is an example in which visual lines of all the users viewing the same image data, in other words, 11 persons of the identifiers A to K, are included. In contrast to this, FIG. 10(c) is an example of image data including visual lines of only some users.

When image data including visual line data is generated, the generation unit 402 of the server 400, as illustrated in FIG. 10(b), may generate image data including the visual lines of all the users. In addition, as illustrated in FIG. 10(c), the generation unit 402 may generate image data including the visual lines of some users.

<<Example in which Users are Grouped Based on Visual Line Information>>

An example of the process performed when users are grouped using visual line information of the users will be described with reference to FIG. 11. FIG. 11 is a flowchart illustrating the process performed by the server 400.

First, the server 400 transmits image data dl stored in the storage device 41 to each head mounted display system 1 connected through the network 500 (S21).

Thereafter, the server 400 receives visual line data of users viewing the image data dl from each head mounted display system 1 (S22).

Next, the server 400 extracts users whose visual lines satisfy a predetermined condition (S23). For example, the server 400, as described above, extracts a group in which the visual lines of users are on the same object, a group in which visual lines of users are in a predetermined range, a group specified by a clustering process, a group in which visual lines of users are in the same area, and the like. At this time, in addition to the visual lines of users, the server 400 may use the behaviors of the users as an extraction condition.

The server 400 generates a group for every extracted user (S24). In accordance with the extraction condition and the visual line data of users, the number of groups and the number of users included in each group are different.

In addition, the server 400 generates new image data including the visual line data of each head mounted display system 1 received in Step S22 and group data generated in Step S24 (S25).

Subsequently, the server 400 transmits the new image data to each head mounted display system 1 (S26).

Until an end request is received, the server 400 continues the process of Steps S22 to S26 (S27).

The process performed by the head mounted display system 1 in this case is the same as the process described above with reference to FIG. 9. In addition, new image data including group data, for example as included in FIG. 12(a), is an image in which identifiers of users can be identified for each group.

More specifically, in the example illustrated in FIG. 12(a), users of identifiers C and H are included in Group 1, users of identifiers D, E, and J are included in Group 2, users of identifiers F and K are included in Group 3, users of identifiers A and B are included in Group 4, and users of identifiers G and I are included in Group 5.

<<Example in which Users of Different Visual Line Information are Guided>>

An example of a process performed when visual lines are guided to a target position in a case in which the visual lines of users are different from the target position will be described with reference to FIG. 13. FIG. 13 is a flowchart illustrating a process performed by the server 400.

First, the server 400 transmits image data dl stored in the storage device 41 to each head mounted display system 1 connected through the network 500 (S31).

Thereafter, the server 400 receives visual line data of users viewing the image data dl from each head mounted display system 1 (S32).

Next, the server 400 extracts users whose visual lines are located at positions other than the target position (S33). For example, the server 400 extracts users whose visual lines are at positions deviating from the coordinates of the target position by a predetermined distance. At this time, in addition to the visual lines of users, the server 400 may use the behaviors of the users as an extraction condition.

The server 400 generates new image data including guide data (S34).

Subsequently, the server 400 transmits the new image data to each head mounted display system 1 (S35).

Until an end request is received, the server 400 continues the process of Steps S32 to S25 (S26).

The process performed by the head mounted display system 1 in this case is the same as the process described above with reference to FIG. 9. For example, as included in FIG. 12(b), the guided data included in the image data indicates a target position and is a symbol, a mark, or the like. For example, an example of the symbol includes a pointer. In the example illustrated in FIG. 12(b), a portion surrounded by a broken line is the target position.

FIGS. 14A to 14C are other examples of an image in which guide data is displayed. In the example illustrated in FIG. 14(a), a mark F1 including a target position (a portion of a broken line) and a user's viewpoint (H portion) is attached to the image based on the guide data. This mark F1, as illustrated in FIGS. 14(b) and 14(c), is gradually decreased with the target position set as the center, thereby guiding the visual lines of users. The shape of the mark F1 is not limited to the shapes illustrated in FIGS. 14A to 14C.

FIGS. 15A to 15C are further examples of an image in which guide data is displayed. In the example illustrated in FIG. 15(a), a mark F2 including a user's viewpoint (H portion) is attached to the image based on the guide data. This mark F2 moves from the user's viewpoint toward a target position (a portion of a broken line) while gradually being enlarged, thereby guiding the visual lines of users. FIG. 15(b) is an example of an image that is in the process of the movement of the mark F2. In addition, FIG. 15(c) is an example of an image in which the mark F2 is moved to the target position. In FIG. 15(b), a circle of a broken line represents the position of the mark F2 illustrated in FIG. 15(a). In addition, in FIG. 15(c), a circle of a broken line represents the position of the mark F2 illustrated in FIG. 15(a) and the position of the mark F2 illustrated in FIG. 15(b).

In addition, a symbol or a mark displayed to indicate a target position may blink at a predetermined time interval, or the size thereof may be changed intermittently. When the symbol or the mark blinks or changes size, the target position can be easily perceived by the user.

According to the image providing system I of the first embodiment having the configuration described above, when image data is provided for head mounted displays of a plurality of users, the image data generated according to a user's visual line data can be provided. For example, the image data may include group data according to the visual line data and guide data. In this way, by using the image providing system I, a plurality of users can be managed.

### Second Embodiment

As illustrated in FIG. 16, in an image providing system II according to a second embodiment, a head mounted display system 1X (hereinafter, referred to as a “host terminal 1X” as is necessary) that is at least one host terminal and a plurality of head mounted display systems 1 (1A to 1C) that are client systems are connected to a server 400.

In the image providing system II according to the second embodiment, a group can be designated from an input device 23 of the host terminal 1X. Alternatively, in the image providing system II, a group can be designated from visual line data detected by a detection unit 202 of the host terminal 1X. In addition, in the image providing system II, user's visual lines can be guided from the host terminal 1X.

### <<Server>>

The server 400 of the image providing system II according to the second embodiment has the same configuration as the server 400 described above with reference to FIG. 2A. In addition, in the image providing system II according to the second embodiment, in the host terminal 1X, group division and guiding of visual lines of users can be performed. For this reason, the classification unit 403 and the extraction unit 404 of the server 400 are not essential configurations.

In addition, a generation unit 402 of the server 400 of the image providing system II can generate new image data including group data and guide data supplied from the head mounted display system 1.

### <<Head Mounted Display System>>

A second communication control unit 201 of the head mounted display system 1 of the image providing system II according to the second embodiment provides group data and guide data input through an input device 23 of a visual line detecting device 200 for the server 400 through a communication I/F 22 together with visual line data detected by a detection unit 202. Here, the visual line detecting device 200X of the host system 1X and the server 400 may be integrally configured.

A process performed by the host terminal 1X will be described with reference to FIGS. 16 and 17. FIG. 17 is an example of an image displayed by the host terminal 1X. FIG. 18 is a flowchart illustrating the process performed by the host terminal 1X.

As illustrated in FIG. 18, the host terminal 1X receives image data from the server 400 (S41). In addition, the host terminal 1X displays the received image data (S42).

Here, before the acquisition of visual line data of users, in the host terminal 1X, as illustrated in FIG. 17(a), an image not including the visual line data is displayed. In addition, after the acquisition of the visual line data of users, in the host terminal 1X, as illustrated in FIG. 17(b), an image including the visual line data of users (for example, identifiers of users) is displayed.

Thereafter, when designation of a group is input to a displayed image (Yes in S43), the host terminal 1X transmits a request signal including group data to the server 400 (S44). The request signal requests the generation of image data including group data that is information according to a visual line. Here, the request signal may request the generation of image data for each group. The designation of a group, for example, is input using an input device 23 such as a mouse or a touch panel. More specifically, as illustrated in FIG. 17(c), a group is designated by enclosing identifiers of users by using the input device 23. Alternatively, for example, the detection unit 202 may detect the visual line of a user using the host terminal 1X so as to designate a group. More specifically, as illustrated in FIG. 17(c), a user using the host terminal 1X may view an image displayed on a display unit 121 and moves a visual line so as to enclose identifiers disposed inside the image, thereby designating a group.

In addition, when guide data is input for the displayed image through the input device 23 (Yes in S45), the host terminal 1X transmits a request signal including the guide data to the server 400 (S46). This request signal requests the generation of image data including guide data guiding a visual line.

Until an end request is received, the host terminal 1X continues the process of Steps S41 to S46 (S26).

According to the image providing system II of the second embodiment having the configuration described above, in a case where image data is provided for head mounted displays of a plurality of users, image data generated according to visual line data of the user can be provided. For example, in the image data, group data according to the visual line data and guide data may be included. In this way, a plurality of users can be managed using the image providing system II.

The technique relating to the visual line detection according to the embodiment described above is an example, and the visual line detecting method using the head mounted display 100 and the visual line detecting device 200 is not limited thereto.

First, in the embodiment described above, while an example is illustrated in which a plurality of infrared light sources emitting near-infrared light as non-visible light are arranged, the technique for emitting near-infrared light to the user's eyes is not limited thereto. For example, in pixels configuring the image display device 108 of the head mounted display 100, pixels each having a sub pixel emitting near-infrared light may be disposed, and near-infrared light may be emitted to the user's eyes by selectively causing sub pixels emitting the near-infrared light to emit light. In addition, alternatively, a configuration may be employed in which a retina projection display is disposed in the head mounted display 100 instead of the image display device 108, and by including pixels emitting light in a near-infrared light color inside an image that is displayed by the retina projection display and is projected to user's retinas, the emission of near-infrared light is realized. Either in the case of the image display device 108 or in the case of the retina projection display, sub pixels emitting near-infrared light may be regularly changed.

In addition, the algorithm for visual line detection represented in the embodiment described above is not limited to the technique represented in the embodiment described above, but any other algorithm realizing visual line detection may be used.

In the embodiment described above, each process of the image providing system has been described to be realized as the CPUs of the server 400, the head mounted display 100, and the visual line detecting device 200 execute an image providing program and the like. On the other hand, in each of the server 400, the head mounted display 100, and the visual line detecting device 200, instead of the CPU, each process may be realized by a logic circuit (hardware) or a dedicated circuit formed in an integrated circuit (IC) chip, large scale integration (LSI), a field programmable gate array (FPGA), a complex programmable logic device (CPLD), or the like. In addition, such a circuit may be realized by one or a plurality of integrated circuits, and the functions of a plurality of functional units illustrated in the embodiment described above may be realized by one integrated circuit. The LSI may be also referred to as VLSI, super LSI, ultra LSI, or the like depending on differences in the degree of integration.

In other words, as illustrated in FIG. 19A, the server 400 may be configured by: a communication I/F 42; a control circuit 40a including a first communication control circuit 401a, a generation circuit 402a, a classification circuit 403a, and an extraction circuit 404a; and a storage device 41 storing image data 411 and an image providing program P1. The first communication control circuit 401a, the generation circuit 402a, the classification circuit 403a, and the extraction circuit 404a are controlled by the image providing program P1. The function of each thereof is similar to that of each unit having the same name represented in the embodiment described above.

In addition, as illustrated in FIG. 19B, the head mounted display 100 may be configured by a communication I/F 110, a third communication control circuit 118a, a display circuit 121a, an infrared light emitting circuit 122a, an image processing circuit 123a, and an imaging circuit 124a. The function of each thereof is similar to that of each unit having the same name represented in the embodiment described above.

Furthermore, as illustrated in FIG. 19B, the visual line detecting device 200 may be configured: by a control circuit 20a including a second communication control circuit 201a, a detection circuit 202a, an image generating circuit 203a, and an image output circuit 204a; a storage device 21 storing a visual detecting program P2; a communication I/F 22; an input device 23; and an output device 24. The second communication control circuit 201a, the detection circuit 202a, the image generating circuit 203a, and the image output circuit 204a are controlled by the visual line detecting program P2. The function of each thereof is similar to that of each unit having the same name represented in the embodiment described above.

In addition, as each of the storage devices 21 and 41 described above, “a medium of a non-temporary type”, for example, a tape, a disk, a card, a semiconductor memory, a programmable logic circuit, or the like may be used. The search program described above may be supplied to the processor described above through an arbitrary transmission medium (a communication network, a broadcast wave, or the like) capable of transmitting the search program. The present invention can be also realized by the form of a data signal embedded in a carrier wave in which the video displaying program described above is embodied through electronic transmission.

In addition, the program, for example, may be implemented using a script language such as ActionScript, JavaScript (registered trademark), Python, or Ruby, a complier language such as a C language, C++, C#, Objective-C, or Java (registered trademark), an assembly language, a register transfer level (RTL), or the like.

### Third Embodiment

FIG. 20 is a block diagram illustrating the configuration of a head mounted display system 1b according to a third embodiment. As illustrated in FIG. 20, a head mounted display 100 of the head mounted display system 1b includes a communication interface (I/F) 110, a communication control unit 118, a display unit 121, an infrared ray emitting unit 122, an image processing unit 123, and an imaging unit 124.

The communication control unit 118 controls communication with a visual line detecting device 200 through the communication I/F 110. The communication control unit 118 transmits image data used for visual line detection, which is transmitted from the imaging unit 124 or the image processing unit 123, to the visual line detecting device 200. In addition, the communication control unit 118 delivers image data or a marker image transmitted from the visual line detecting device 200 to the display unit 121. The image data, for example, is data used for displaying a test. In addition, the image data may be a parallax image pair formed by a right-eye parallax image and a left-eye parallax image used for displaying a three-dimensional image.

The display unit 121 has a function for displaying the image data delivered from the communication control unit 118 on an image display device 108. The display unit 121 displays a test image as image data. In addition, the display unit 121 displays a marker image output from the video generating unit 222 at designated coordinates of the image display device 108.

The infrared ray emitting unit 122 emits infrared light to the right eye or the left eye of a user by controlling an infrared light source 103.

The image processing unit 123 performs image processing for an image captured by the imaging unit 124 as is necessary and delivers the processed image to the communication control unit 118.

The imaging unit 124 captures an image including near-infrared light reflected by each eye by using a camera 116. In addition, the imaging unit 124 captures an image including the eye of a user gazing at the marker image displayed on the image display device 108. The imaging unit 124 delivers the images acquired through the capturing process to the communication control unit 118 or the image processing unit 123.

As illustrated in FIG. 20, the visual line detecting device 200 is an information processing apparatus including a central processing unit (CPU) 20, a storage device 21 storing the image data 211 and the data generating program P3, a communication I/F 22, an input device 23 such as operation buttons, a keyboard, or a touch panel, and an output device 24 such as a display or a printer. In the visual line detecting device 200, as the data generating program P3 stored in the storage device 21 is executed, the CPU 20 performs processes as a communication control unit 201b, a detection unit 202b, an analysis unit 203b, a timer 204b, an operation acquiring unit 205b, an attribute acquiring unit 206b, a generation unit 207b, and an output unit 208b.

The image data 211 is data to be displayed on the head mounted display 100. The image data 211 may be either a two-dimensional image or a three-dimensional image. In addition, the image data 211 may be either a still image or a moving image.

For example, the image data 211 is moving image data of a video game. When the image data 211 is an image of a video game, an image to be displayed is changed according to an operation signal input by a user. In addition, for example, the image data 211 is moving image data of a movie. The image data 211 may be purchased from a connected external server apparatus or the like (not illustrated in the drawing) in accordance with a user's operation.

The communication control unit 201b controls communication with the head mounted display 100 through the communication I/F 22.

The detection unit 202b detects a user's visual line and generates visual line data.

The analysis unit 203b analyzes a user's visual line by using the visual line data. Here, the analysis unit 203b uses data input from the timer 204b, the operation acquiring unit 205b, and the attribute acquiring unit 206b as is necessary.

When the image data 211 is moving image data of a game, the timer 204b measures a user's play time of the game. In addition, the timer 204b outputs measured time data to the analysis unit 203b. For example, the timer 204b measures an attainment time from the start of the game to the end (game clear). Here, in a case where a user plays the same game a plurality of number of times, the timer 204b measures an attainment time from the start of the game of the first time to the end. In addition, for example, the timer 204b measures a total play time of the game. Here, in a case where a user plays the same game a plurality of number of times, the timer 204b measures a sum of play times of a plurality of number of times as a total play time (total time).

The operation acquiring unit 205b receives various operation signals input relating to the display of the image data 211. In addition, the operation acquiring unit 205b outputs data relating to an operation signal to the analysis unit 203b. For example, when the image data 211 is data of a game, information of a user's operation performed in the game is acquired. Here, the user's operation may be an operation according to the movement of a visual line that can be detected by the detection unit 202b in addition to an operation input using an input button or an operation according to the input of an audio signal.

The attribute acquiring unit 206b acquires attribute data of a user using the image data 211. In addition, the attribute acquiring unit 206b outputs the acquired data to the analysis unit 203b. The attribute data, for example, is data relating to user's sex, age, occupation, and the like. For example, in a case where the head mounted display system 1 is connected to a management server or the like, and the user is registered in the management server, the attribute data can be acquired from the registration information. Alternatively, the attribute data of the user may be stored in the storage device 21 of the visual line detecting device 200.

The generation unit 207b generates visualization data including a result of the detection acquired by the detection unit 202b and a result of the analysis acquired by the analysis unit 203b. For example, in a case where a specific visual line is analyzed by the analysis unit 203b, the generation unit 207b generates visualization data including an image and data (a point representing coordinates or a trajectory of a visual line) specified by a visual line corresponding to the image. As the visualization data, heat map data, data representing a result of the analysis as a graph, or the like may be considered. Here, when the image data is moving image data, the visualization data may include a time axis display section specifying a relation between a user′ viewpoint in an image and a time axis of one image in the image data. In addition, when the result of the analysis acquired by the analysis unit can be represented as a bar graph or the like, data including the bar graph is generated as the visualization data.

The output unit 208b outputs the visualization data generated by the generation unit 207b to the output device 24 and the like.

In addition, among the units of the visual line detecting device 200 described above, the analysis unit 203b, the timer 204b, the operation acquiring unit 205b, the attribute acquiring unit 206b, and the generation unit 207b may be realized by an information processing apparatus such as an external server or the like. In a case where such processing units 203b to 207b are realized by an external information processing apparatus, an acquisition unit acquiring visual line data detected by the detection unit 202b of the head mounted display system 1 is included in the information processing apparatus, and the analysis unit 203b performs a data analyzing process by using the visual line data acquired by the acquisition unit.

### <<Visualization Data Generating Process 1>>

A process performed in a case where visualization data is generated and output by the head mounted display system 1b will be described with reference to a flowchart illustrated in FIG. 21(a).

The head mounted display system 1b, first, displays target image data 211 (S51).

When an image is displayed, the head mounted display system 1b detects a visual line of a user viewing the displayed image data 211 (S52).

When the visual line of a user is detected, the head mounted display system 1b analyzes the detected visual line of the user (S53).

When the visual line is analyzed, the head mounted display system 1b generates visualization data (S54).

The head mounted display system 1b outputs the generated visualization data (S55).

Here, FIG. 20 illustrates an example in which one head mounted display 100 is connected to one visual line detecting device 200. However, a plurality of head mounted displays 100 may be connected to one visual line detecting device 200. In such a case, in order to display the image data 211 on each head mounted display 100 and detect visual line data from each user, the process of Steps S01 and S02 is repeated a plurality of number of times. In addition, the process of Steps S53 to S55 is repeated using the visual line data detected from a plurality of users.

FIGS. 22A and 22B are examples of visualization data generated by using visual line data of a plurality of users in a case where a certain still image is displayed for a predetermined time. The example illustrated in FIG. 22(a) illustrates visualization data W1 including the trajectories S1 to S4 of the visual lines of the users. The example illustrated in FIG. 22(b) illustrates visualization data W2 including bar graphs representing positions at which users gaze for a predetermined time or more.

FIGS. 23A to 23C illustrate an example of visualization data generated using visual line data of users in a case where a moving image is displayed. FIGS. 23(a) and 23(b) illustrate visualization data W3 including a time slider T representing the status of progress of the moving image. Regarding FIGS. 23(a) and 23(b), an image of FIG. 23(a) is displayed first, and thereafter, an image of FIG. 23(b) is displayed. Here, in FIGS. 23(a) and 23(b), black circle portions are the positions of users' visual lines.

### <<Visualization Data Generating Process 2>>

A process performed in a case where visualization data is generated and output by the head mounted display system 1b will be described with reference to a flowchart illustrated in FIG. 21(b).

The head mounted display system 1b acquires visual line data of users (S61).

In addition, when the visual line data of the users is acquired, the head mounted display system 1b analyzes the acquired visual lines of the users (S62).

When the visual lines are analyzed, the head mounted display system 1b generates visualization data (S63).

The head mounted display system 1b outputs the generated visualization data (S64).

The process of these Steps S11 to S14 may be performed not by the head mounted display system 1b but by an information processing apparatus such as an external server including an acquisition unit acquiring a result detected by the detection unit 202b, the analysis unit 203b, the timer 204b, the operation acquiring unit 205b, the attribute acquiring unit 206b, the generation unit 207b, and the like.

When the image data 211 is data of a video game, the analysis unit 203b, for example, can analyze the following contents (1-1) to (1-6).

### (1-1) User's Viewpoint Until Visual Line Move to Target Position

The trajectory of a user's visual line until the user's visual line moves to a target position and a time required for the user's visual line to move to the target position are analyzed. The time required for the user's visual line to move to the target position, for example, can be specified based on a time input from the timer 204b. In this way, for example, the degree of easiness in finding a target position in a displayed image can be acquired. In addition, the generation unit 207b generates a graph of a time required for each user's visual line to arrive at a target position as visualization data.

In addition, by collecting and analyzing the data of a plurality of users, the analysis unit 203b can analyze the tendency of image data for which a user can easily find a target position. Furthermore, by analyzing the image data in combination with user's attributes, the analysis unit 203b can analyze a time required for each visual line to move to a target position and the tendency of a user's attribute. The user's attributes are input from the attribute acquiring unit 206b.

(1-2) Viewpoint of User Whose Visual Line Deviate from Target Position

In a case where the user's visual line is not present at a target position, the analysis unit 203b analyzes the coordinates (viewpoint) of the user's visual line at that time point. In this way, in a displayed image, a place by which the user is attracted and led astray can be specified. For example, the generation unit 207b generates the coordinates of the user's viewpoint as the visualization data.

In addition, by collecting and analyzing the data of a plurality of users, the analysis unit 203b can analyze the tendency of image data for which a user is easily led astray. Furthermore, by analyzing the image data in combination with the user's attributes, the analysis unit 203b can analyze the tendency of user's attributes for which the user is easily led astray. The user's attributes are input from the attribute acquiring unit 206b.

(1-3) Reason for Case where Visual Line Deviates from Target Position

In a case where a user's visual line is not present at a target position, the analysis unit 203b acquires the trajectory of the user's visual line in images displayed for a predetermined time until reaching the state. In this way, in images displayed until reaching a certain state, the reason of an object by which the user is attracted and led astray can be predicted. For example, the generation unit 207b generates the trajectory of a user's viewpoint as the visualization data.

In addition, by collecting and analyzing the data of trajectories of visual lines of a plurality of users, the analysis unit 203b can analyze image data for which a user is easily led astray. Furthermore, by analyzing the image data in combination with user's attributes, the analysis unit 203b can analyze the tendency of users who are easily less astray.

### (1-4) User's Position of Interest on Initial Screen

The analysis unit 203b detects the coordinates of a user's visual line on the initial screen of a game. In this way, the analysis unit 203b analyzes a place on the initial screen to which a user gives attention. In other words, by analyzing a place to which the user gives attention on the initial screen, the analysis unit 203b can perceive a place by which the user is attracted on the initial screen. For example, the generation unit 207b generates the coordinates of the user's viewpoint as the visualization data.

In addition, by collecting and analyzing the visual line data of a plurality of users, the analysis unit 203b can analyze an image configuration by which many users are attracted. Furthermore, by analyzing the image configuration in combination with user's attributes, the analysis unit 203b can analyze the tendency of users attracted by each image configuration.

In addition, by analyzing the image configuration in combination with a user's total play time, the analysis unit 203b can analyze data by which the user is easily attracted and the tendency of degree of user's interest in the game. For example, a user having a long total play time is frequently a user having a preference for a target game, and a user having a short total play time is frequently a user having no interest in the target game. Thus, for example, by analyzing data by which a user is attracted and the play time of the user in combination with each other, a difference in the viewpoints of a user having interest in the game and a user having no interest in the game can be analyzed. The user's total play time is input from the timer 204b.

### (1-5) Tendency of User Performing Specific Operation

The analysis unit 203b detects the coordinates (viewpoint) of the visual line of a user performing a specific operation in a game. In this way, the interest and concern of a user performing each operation can be specified. This operation may be either an operation relating to the play of the game or any other operation. The analysis unit 203b receives data relating to the execution of an operation from the operation acquiring unit 205b. For example, the generation unit 207b generates the coordinates of the viewpoint of a user as the visualization data.

For example, by checking an operation relating to the play of a game and the user's viewpoint at the time of performing the operation, a relation between the user's operation and the visual line can be acquired. As the user's operation, for example, in the case of a game for acquiring a score, the visual line of a user performing an operation acquiring a high score may be considered. In addition, as an operation other than the play of the game, for example, there is an operation of purchasing a content in the game. For example, by analyzing a certain point in which a user purchasing a content has interest for purchasing the content, a game development for which a user purchases a content and an image configuration preferred by a user purchasing many contents can be specified.

In addition, by collecting and analyzing the data of visual lines of a plurality of users and data relating to the execution of an operation, the analysis unit 203b can analyze a relation between a user's operation and image data. Furthermore, by analyzing the data in combination with user's attributes, the analysis unit 203b can analyze the tendency of users performing each operation.

In addition, by analyzing the data in combination with a user's total play time, the analysis unit 203b can analyze a user performing a specific operation and the tendency of degree of user's interest in a user game. For example, a user having a long total play time is frequently a user preferring a target game, and a user having a short total play time is frequently a user having no interest in the target game. Thus, for example, a relation between the execution of a specific operation and a user having interest in the game and a user having no interest in the game can be analyzed.

### (1-6) User's Level

In the case of a game in which a user's level can be acquired from a score acquired in the game or the like for the analysis of (1) to (4), the analysis unit 203b may consider the level. In other words, for each user's level, a viewpoint of a user having a visual line deviating from a target position, a reason for a case where the visual line deviates from the target position, a user's position of interest on an initial screen, and the tendency of users performing a specific operation can be analyzed.

When the image data 211 is data of a movie, for example, the following contents (2-1) to (2-3) can be analyzed.

### (2-1) User's Position of Interest

The analysis unit 203b detects the coordinates (viewpoint) of a user's visual line inside an image. In this way, on a display image, a place attracted by the user can be specified. In addition, by collecting and analyzing the data of a plurality of users, the configuration of an image attracted by a plurality of users can be specified.

### (2-2) User's Attribute

The analysis unit 203b may analyze user's attributes together with a user's position of interest of (2-1) described above. In this way, the tendency of a user's attribute preferring the configuration of each image can be analyzed altogether as well. The user's attributes are input from the attribute acquiring unit 206b.

### (2-3) Purchase History of Content

The analysis unit 203b may analyze a user's purchase history of a movie content together with the user's position of interest of (2-1) described above and the user's attributes of (2-2) described above. Examples of the purchase history include the price of a movie content and, in the case of an online purchase, purchase date and time, and the like. In this way, the tendency of purchases of a content can be analyzed altogether.

In this way, the analysis unit 203b analyzes the viewpoint of a specific user and the tendency of a plurality of viewpoints of users.

### Fourth Embodiment

FIG. 24 is a block diagram of a head mounted display 100 and a visual line detecting device 200 of a video display system 1c according to a fourth embodiment.

The head mounted display 100 includes a control unit (CPU) 150, a memory 151, an infrared ray emitting unit 122, a display unit 121, an imaging unit 124, an image processing unit 123, and an inclination detecting unit 156 in addition to an infrared light source 103, an image display device 108 (hereinafter, referred to as a “display 108”), a camera 116, and a communication I/F 110 as electric circuit components.

Meanwhile, the visual line detecting device 200 includes a control unit (CPU) 20, a storage device 21, a communication I/F 22, a visual line detecting unit 213, a video generating unit 214, and an audio generating unit 215.

The communication I/F 110 is a communication interface having a function for communicating with the communication I/F 22 of the visual line detecting device 200. The communication I/F 110 communicates with the communication I/F 22 through wired communication or wireless communication. Examples of the communication standard that can be used are as described above. The communication I/F 110 transmits video data used for visual line detection, which is transmitted from the imaging unit 124 or the image processing unit 123, to the communication I/F 22. In addition, the communication I/F 110 delivers video data and a marker image transmitted from the visual line detecting device 200 to the display unit 121. The video data transmitted from the visual line detecting device 200 is data used for displaying a moving image including a video of one or more persons or the like such as a PV as an example. In addition, the video data may be a parallax video pair configured by a right-eye parallax video and a left-eye parallax video used for displaying a three-dimensional video.

The control unit 140 controls the electric circuit components described above by using a program stored in the memory 151. Thus, the control unit 140 of the head mounted display 100 may execute a program realizing a visual line detecting function in accordance with a program stored in the memory 151.

The memory 151 can temporarily store image data captured by the camera 116 and the like as is necessary in addition to the storing of the program used for the function of the head mounted display 100 described above.

The infrared ray emitting unit 122 emits near-infrared light to the right eye or the left eye of the user 300 from the infrared light source 103 by controlling the lighting state of the infrared light source 103.

The display unit 121 has a function for displaying video data delivered by the communication I/F 110 on the display 108. The display unit 121 displays a video including one or more persons such as a promotion video (PV) of an idol group or the like, a live video of various concerts or the like, and a lecture video of a talk show or the like. In addition, the display unit 121 displays a marker image output by the video generating unit 214 at designated coordinates on the display unit 121.

The imaging unit 124 captures an image including near-infrared light reflected by the left and right eyes of the user 300 by using the camera 116. In addition, the imaging unit 124 captures a bright spot image and an anterior ocular segment image of the user 300 gazing at the marker image displayed on the display 108 to be described later. The imaging unit 124 delivers image data acquired through the capturing process to the communication I/F 110 or the image processing unit 123.

The image processing unit 123 performs image processing for the image captured by the imaging unit 124 as is necessary and delivers the processed image to the communication I/F 110.

The inclination detecting unit 156 calculates the inclination of the head part of the user 300 as the inclination of the head mounted display 100, for example, based on a detection signal supplied from an inclination sensor 157 such as an acceleration sensor or a gyro sensor. The inclination detecting unit 156 sequentially calculates the inclinations of the head mounted displays 100 and delivers inclination information that is a result of the calculation to the communication I/F 110.

The control unit (CPU) 210 performs the visual line detection described above by using a program stored in the storage device 21. The control unit 210 controls the video generating unit 214 and the audio generating unit 215 in accordance with a program stored in the storage device 21.

The storage device 21 is a recording medium storing various programs and data that are required for the operation of the visual line detecting device 200. The storage device 21, for example, can be realized by a hard disc drive (HDD), a solid state drive (SSD), or the like. The storage device 21 stores information of a position on the outer surface of the display 108 that corresponds to each person appearing in a video corresponding to the video data and audio information of each person.

The communication I/F 22 is a communication interface having a function for communicating with the communication I/F 110 of the head mounted display 100. As described above, the communication I/F 22 communicates with the communication I/F 110 through wired communication or wireless communication. The communication I/F 22 transmits video data used for displaying a video including one or more persons, a marker image used for calibration, and the like, which are delivered by the video generating unit 214, to the head mounted display 100. In addition, the communication I/F 22 delivers the bright spot image of a user 300 gazing at the marker image captured by the imaging unit 124, which is delivered by the head mounted display 100, the anterior ocular segment image of a user 300 viewing a video displayed based on the video data output by the video generating unit 214, and the inclination information calculated by the inclination detecting unit 156 to the visual line detecting unit 213. In addition, the communication I/F 22 may be configured to access an external network (for example, the Internet), acquire video information of a moving image web site designated by the video generating unit 214, and deliver the acquired video information to the video generating unit 214. Furthermore, the communication I/F 22 transmits audio information delivered by the audio generating unit 215 to the headphones 170 directly or through the communication I/F 110.

The visual line detecting unit 213 detects a visual line direction of the user 300 by analyzing the anterior ocular segment image captured by the camera 116. More specifically, the visual line detecting unit 213 receives video data used for detecting the visual line of the right eye of the user 300 from the communication I/F 22 and detects the visual line direction of the right eye of the user 300. The visual line detecting unit 213, by using a technique to be described later, calculates a right-eye visual line vector representing the visual line direction of the right eye of the user 300. Similarly, the visual line detecting unit 213 receives video data used for detecting the visual line of the left eye of the user 300 from the communication I/F 22 and calculates a left-eye visual line vector representing the visual line direction of the left eye of the user 300. Then, the visual line detecting unit 213 specifies a portion of a video displayed on the display unit 121 at which the user 300 gazes. The visual line detecting unit 213 delivers the specified gazing point to the video generating unit 214.

The video generating unit 214 generates video data to be displayed on the display unit 121 of the head mounted display 100 and delivers the generated video data to the communication I/F 22. The video generating unit 214 generates marker images used for the calibration for visual line detection and delivers the generated marker images to the communication I/F 22 together with the display coordinate position thereof to be transmitted to the head mounted display 100. In addition, the video generating unit 214 generates video data of which the display form of the video is changed according to the visual line direction of the user 300 that is detected by the visual line detecting unit 213. The method of changing the display form of a video will be described later in detail. The video generating unit 214 determines whether or not the user 300 gazes at one specific person based on the gazing point delivered by the visual line detecting unit 213 and, in a case where the user gazes at the one specific person, specifies the one person.

In a case where one or more persons are present in a video output by the display 108 in the visual line direction of the user 300 that is detected by the visual line detecting unit 213, the audio generating unit 215 specifies the person and generates audio data such that the output state of a voice output from the headphones 170 in correspondence with the specified person is different from the output state of the other voices so as to be identifiable for the user 300.

For example, the audio generating unit 215 generates audio data to be identifiable for the user 300 by increasing the volume of the sound of the specified person or decreasing the volume of the voices of persons other than the specified person such that the volume of the sound the specified person is larger than that of the other sounds.

In addition, the audio generating unit 215 may give an additional function of modulating, increasing (decreasing) a modulation tempo, or enhancing the sound to the audio data in addition to the increasing of the volume of the sound of the specified person to be larger than the volume of the other voices. The audio generating unit 215 may give an additional function of causing music of a musical performance or the like to be mute during an interlude of a pop song music video (PV) or the like to the audio data. In addition, while details will be described later, in a case where music is caused to be mute during an interlude by the audio generating unit 215, the video generating unit 214 may give an additional function of slowing down the video so as to slowly view the choreography of a specified person or the like.

The video generating unit 214 may generate video data such that the user can more easily gaze at a video of a predetermined area including at least a part of a specified person than a video of an area other than the predetermined area based on the visual line direction of the user 300. For example, an additional function of highlighting such as application of smoke to a portion other than the specified person, moving the video data such that the specified person is positioned at the center of the display 108, or zooming up a part of the specified person such as a face or an instrument may be given. In addition, for example, in promotion videos of recent years, for the same musical piece, one musical piece is configured by combining videos a plurality of patterns in which characters, a film set or a filming location (regardless of being natural or artificial), choreography, costumes, or the like are different from each other. For this reason, there is also a case where a different video pattern can be selected for the same melody part. For this reason, for example, an additional function of performing switching to a video pattern in which a specified person appears more frequently or following a specified person when the specified person moves may be given.

### <<Data>>

Here, specific video data will be described. For example, generally, in a promotion video of an idol group or the like, video capturing and generation and audio (singing and playing) recording are separately performed.

At this time, singing is individually performed regardless whether the part is a part in which all the members sing or a part in which an individual sings (solo part). Accordingly, a sound and playing can be easily specified for each person and thus can be used as known information.

Meanwhile, also for a video, in an outdoor place or a studio, there are a case where all the members are imaged and a case where an individual is imaged, and, finally, image processing such as background processing is usually performed. Thus, by combining (linking) the video with an audio, a relation between the video and the time axis can be also used as known information. In addition, also when each person moves according to choreography or the like on the screen, for a screen size (aspect ratio) set in advance, for example, a position according to the time axis using a face as the reference can be easily used as known information.

In this way, on the display screen of the display 108 described above, relating to each person (character) on a video, a sound (playing) and a position are embedded in video data in association with the time axis, or performer data of a table system corresponding to the video data can be formed.

Accordingly, when the visual line position of the user 300 is detected by the visual line detecting unit 213, the control unit 210 can specify a person in the video who is intensively viewed by the user 300 from the XY coordinates of the visual line position and a time table.

### <<Operation>>

Next, the operation of the video display system 1c will be described with reference to a flowchart illustrated in FIG. 25. In the following description, the control unit 210 of the visual line detecting device 200 is assumed to transmit video data including audio data from the communication I/F 22 to the communication I/F 110.

### (Step S71)

In Step S71, the control unit 140, by operating the display unit 121 and the audio output unit 132, outputs a video to the display 108 so as to be displayed thereon and outputs an audio from the audio output unit 132 of the headphones 170, and the process proceeds to Step S72.

### (Step S72)

In Step S72, the control unit 210, based on image data captured by the camera 116 detects a gazing point (visual line position) of the user 300 on the display 108 by using the visual line detecting unit 213 and specifies the position.

### (Step S73)

In Step S73, the control unit 210 determines whether or not the user 300 gazes at one specific person. More specifically, the control unit 210 determines whether or not the user 300 gazes at one specific person, also in a case where a person in the video moves or the like in a time series, based on whether or not a change in the XY coordinate axis at a detected fixation point changing in the time axis coincides with an XY coordinate axis on the video following the time table for a predetermined time (for example, two seconds) with an XY coordinate axis that is initially specified used as a base point. In a case where the control unit 210 determines that the user gazes at one specific person (Yes), the process proceeds to Step S4. On the other hand, in a case where the control unit 210 determines that the user does not gaze at one specific person (No), the process proceeds to Step S78. In addition, also in a case where one specific person does not move, the specifying sequence described above is the same.

### (Step S74)

In Step S74, the control unit 210 specifies a person at whom the user 300 gazes, and the process proceeds to Step S75.

### (Step S75)

In Step S75, the control unit 210 specifies the audio data of the specified person, and the process proceeds to Step S76.

### (Step S76)

In Step S76, the control unit 210 causes the audio generating unit 215 to generate audio data of the specified person and audio data of the other persons (a musical performance may be either included or excluded) and transmits new audio data after the generation from the communication I/F 22 to the communication I/F 110, and the process proceeds to Step S7. In this way, for example, the audio data is output from the headphones 170 in a state in which the volume of the singing voice of the person at whom the user 300 gazes is higher than that of the other persons as a result. In addition, the audio generating unit 215 enables the user 300 to easily identify the singing of the one specified person by configuring the voice of the specified person to stand out from the voices of the other persons by increasing only the volume of the singing voice of a person at whom the user 300 gazes or, to the contrary, decreasing the volume of the singing voices of persons other than the person at whom the user 300 gazes.

### (Step S77)

In Step S77, actually, in parallel with the routine of Step S76 described above, the control unit 210 causes the video generating unit 214 to generate new video data such that the person at whom the user 300 gazes can be easily identified and transmits the new video data after the generation from the communication I/F 22 to the communication I/F 110, and the process proceeds to Step S7. In this way, on the display 108, for example, display is performed from a normal video display state illustrated in FIG. 26, as illustrated in FIG. 27, to a state in which the video of the specified person (for example, a girl singing at the center position) is maintained as it is, but the videos of the other persons disposed on the periphery thereof are veiled. In other words, the video generating unit 214 performs an emphasizing process in which video data is newly generated such that the user can gaze at the video of a predetermined area (the girl positioned at the center) more easily than the videos of areas other than the predetermined area.

### (Step S78)

In Step S78, the control unit 210 determines whether or not the reproduction of the video data has ended. In a case where the generation of the video data is determined to have ended (Yes), the control unit 210 ends this routine. On the other hand, in a case where the generation of the video data is determined not to have ended (No), the control unit 210 loops to Step S2, and thereafter, each routine described above is repeated until the reproduction of the video data ends. Accordingly, for example, in a case where the user 300 desires to stop the video output that is in the emphasized state, by only stopping to gaze at the specific person at whom the user has gazed, it is not determined that the user gazes at one specific person (No in Step S73), and the emphasized display and the audio control are stopped.

### <Summary>

In this way, the video display system 1c, by using the audio generating unit 215, in a case where one or more persons are present in a video output from the display 108 in the visual line direction of the user 300 that is detected by the visual line detecting unit 213, specifies the person and generates audio data such that the output state of a voice (including instrument playing and the like) output from the audio output unit 132 in correspondence with the specified person is different from the output state of the other voices so as to be identifiable for the user 300.

For example, in an idol group of a taste, the volume of the singing voice of a recommended member can be configured to be higher than that of the other members as a result such that the singing voice of the recommended member is distinguished more than that of the other members.

In this way, the user 300 can easily recognize a sound of the singing voice (part) of the recommended member and thus can enjoy viewing of a promotion video.

Here, the specific person is not limited to a member of an idol group or the like, and a player of a backband in a live video of a concert or the like may be set as a target.

In such a case, by specifying the player and raising the volume of the play sound (for example, the sound of a main guitar or the sound of a bass guitar), the audio data can be provided for a study on a way of playing and arrangements.

At this time, as in the production of the promotion video described above, also in a case where a video and an audio are recorded in the same period instead of separately recording a video and an audio, when a used microphone can be specified at the time of editing the video, the video and the audio can be easily associated with each other. In addition, for example, also in a case where a microphone is not used, since there is a natural frequency or the like in an instrument or a sound, by configuring a person and a sample voice (codec or the like) as a database by using a table system, a person included in the video can be associated with a voice.

Furthermore, all the videos in which a plurality of persons appear, for example, all the videos of various plays and operas or various lectures such as talk shows in which a plurality of characters are included can be applied as the video data, and it is particularly useful in a case where voices are mixed.

In this way, the output can be changed according to a practical use form, and thus, the versatility can be improved.

Here, as techniques for improving the identifying of a voice performed by the user 300 in the audio generating unit 215, there are a technique of raising the volume of the voice of a specific person, a technique of lowering the volume of voices of the other persons with the volume of the voice of the specific person being maintained as it is, and the like.

In addition, the audio generating unit 215 may add an additional function of applying modulation partially or wholly, changing the tempo, or enhancing a voice in a state in which the volume of the voice of such a specific person is higher than that of the other persons as a result.

Furthermore, in a case where there is an interlude as in a pop song, the audio generating unit 215 may cause the sound (an instrumental sound, or the like) to be mute during the interlude. Accordingly, such a function can be used also in a case where the choreography of a specific person is to be memorized together with video incorporation such as slowly reproducing a choreography (dance) video of the specific person or the like by using the function of the video generating unit 214.

In addition, in a case where the video generating unit 214 is used together in addition to the audio control performed by the audio generating unit 215, for example, the display form may be changed such that the user can more easily gaze at the video of a predetermined area including at least a part of a person specified based on the visual line direction of the user 300, which is detected by the visual line detecting unit 213, than the video of an area other than the predetermined area.

As specific examples of a case in which the video generating unit 214 is used together in addition to the audio control performed by the audio generating unit 215, in addition to a form in which the whole specific person as a predetermined area has a display form emphasized more than the other area as illustrated in FIG. 7 described above, there are a form in which, in a case where the video of a specific person is not displayed near the center on the screen, the specific person is moved to a position near the center on the screen, a form in which the face of a specific person or an instrument (an appearance of playing or the like) held by an instrument player is zoomed up, a form in which, in a case where a plurality of video patterns are present for the same music, switching to video data (camera) in which the specific person appears is performed.

### <Supplement>

In addition, the video display system is not limited to the embodiments described above but may be realized by using the other techniques. Hereinafter, examples of the other techniques will be described.

(1) In the embodiments described above, while a video such as a promotion video or a live video is used, and an example of a video in a real space including a combined use is illustrated, a case where a similar person, instrument, music, or the like is displayed in a virtual reality space may be applied.
(2) In the embodiments described above, while an example has been illustrated in which the volume of the voice of a specific person is higher than that of the other voices as a result, for example, in a case where the specific person is not a so-called main vocal, the sound of the specific person may be interchanged with the sound of the main vocal to be like a main vocal.
(3) In the embodiments described above, in order to detect the visual line of the user 300, as a technique for imaging the eyes of the user 300, while a video reflected by the optical device 112 such as a wavelength control member is captured, the eyes of the user 300 may be directly captured not through the optical device 112.
(4) The technique relating to the visual line detection in the embodiments described above is an example, and the method of detecting a visual line using the head mounted display 100 and the visual line detecting device 200 is not limited thereto.

First, while an example is illustrated in which a plurality of infrared ray emitting units emitting near-infrared light as non-visible light are disposed, the technique for emitting near-infrared light to the eyes of the user 300 is not limited thereto. For example, in pixels configuring the image display device 108 of the head mounted display 100, pixels each having a sub pixel emitting near-infrared light may be disposed, and near-infrared light may be emitted to the eyes of the user 300 by selectively causing sub pixels emitting the near-infrared light to emit light. In addition, alternatively, a configuration may be employed in which a retina projection display is disposed in the head mounted display 100 instead of the image display device 108, display is made by the retina projection display, and pixels emitting light in a near-infrared light color are included inside a video projected to the retinas of the user 300, whereby the emission of near-infrared light is realized. Either in the case of the display 108 or in the case of the retina projection display, sub pixels emitting near-infrared light may be regularly changed.

In addition, the algorithm for visual line detection is not limited to the technique described above, but any other algorithm realizing visual line detection may be used.

(5) In the embodiments described above, an example has been illustrated in which the audio form of a specific person is changed based on whether or not a person at whom the user 30 gazes for a predetermined or more is present. In the process, the following process may be further added. In other words, the eyes of the user 300 are imaged using the imaging unit 124, and the visual line detecting device 200 specifies the motion (a change of the open state) of the pupils of the user 300. Then, the visual line detecting device 200 may include a feeling specifying unit specifying the feeling of the user 300 in accordance with the open state of the pupils. Then, the video generating unit 214 may be configured to change the voice in accordance with the feeling specified by the feeling specifying unit. More specifically, for example, in a case where the pupils of the user 300 are widely open, it is determined that the person at whom the user 300 gazes has an expression of a taste or performs choreography of a taste, and the user 300 is estimated to have interest attracted to the person. Then, in a case where a video having the same tendency as the video of the expression or the choreography to which the user 300 has interest attracted is displayed (for example, a second high-point melody for a first high-point melody of a musical piece), the audio generating unit 215 raises the volume of the voice of a specific person to increase a difference from the volume of the voices of the other persons, and accordingly, an emphasizing effect including a video attracting the interest of the user 300 can be promoted. Similarly, the video generating unit 214 can change the emphasis of the video at that time to a further emphasis (for example, surrounding shading is thickened).
(6) In the embodiments described above, while an example is illustrated in which the display form such as an emphasis made by the video generating unit 214 is changed simultaneously with the change in the voice form made by the audio generating unit 215, in the change in the display form, for example, switching to a CM video for selling a product or other PV relating to an idol at whom the user gazes through the internet may be performed.

### <<Other Applications>>

An image providing system according to the present invention may be an image providing system in which a server further includes a classification unit classifying a plurality of users as a group of users whose positions of the visual lines in image data satisfy a predetermined condition, and a generation unit generates image data for each user belonging to the group classified by the classification unit.

In addition, the image providing system may be an image providing system in which a server further includes an extraction unit extracting users whose gazing positions in visual lines are different from a target position, and a generation unit generates image data guiding the users extracted by the extraction unit to the target position.

Furthermore, the image providing system may be an image providing system in which a request signal includes group information relating to the group of classified users, and a generation unit generates image data including the group information.

In addition, the image providing system may be an image providing system in which a request signal includes guide information guiding a visual line, and a generation unit generates image data including the guide information.

A server according to the present invention is a server that is connected to a plurality of head mounted display systems and is used for an image providing system and may be a server including a first communication control unit transmitting image data to the connected head mounted display systems and a generation unit generating new image data according to information relating to visual lines of users transmitted from the head mounted display systems in accordance with the image data and outputting the generated new image data to the first communication control unit.

An image providing method according to the present invention is an image providing method used in an image providing system in which a server and a plurality of head mounted display systems are connected and may be an image providing method including: transmitting image data to the connected head mounted display systems by using the server; displaying the image data supplied from the server by using the head mounted display systems; detecting a visual line of a user viewing the image data displayed on a display unit by using each of the head mounted display system; transmitting information relating to the detected visual line to the server by using each of the head mounted display systems; and generating new image data according to the information relating to the visual line of the user transmitted from each of the head mounted display systems and transmitting the generated new image data to the head mounted display systems by using the server.

An image providing program according to the present invention may be an image providing program in an image providing system in which a server and a plurality of head mounted display systems are connected that realizes: transmitting image data to the connected head mounted display systems; and generating new image data according to information relating to the visual line of the user transmitted from each of the head mounted display systems in accordance with the image data and transmitting the generated new image data to the head mounted display systems in the server.

A head mounted display according to the present invention may be a head mounted display system including: a display unit displaying an image; a detection unit detecting visual line data of a user viewing the image displayed on the display unit; and a generation unit generating visualization data according to the detected visual line data of one or more users.

In addition, the generation unit of the head mounted display system may generate visualization data including the coordinate position of a viewpoint of a user specified by the visual line data detected by the detection unit.

In addition, the head mounted display system may further include an analysis unit analyzing the tendency of a plurality of viewpoints of users viewing an image displayed on the display unit from the visual line data detected by the detection unit, and the generation unit may generate visualization data including a result of the analysis acquired by the analysis unit.

In addition, the head mounted display system may include an analysis unit analyzing a viewpoint of a user in a case where a visual line of the user is not present at a predetermined target position inside the image displayed on the display unit in the visual line data detected by the detection unit, and the generation unit may generate visualization data including a result of the analysis acquired by the analysis unit.

In addition, the head mounted display system may include an analysis unit analyzing the trajectory of the visual line of the user for a predetermined time until an image is displayed in a case where a visual line of the user is not present at a predetermined target position inside the image displayed on the display unit in the visual line data detected by the detection unit, and the generation unit may generate visualization data including a result of the analysis acquired by the analysis unit.

In addition, in the head mounted display system, image data used for displaying an image is moving image data of a video game, a timer measuring an attainment time of the game is further included, and the analysis unit may analyze the attainment time measured by the timer and the visual line of the user.

In addition, the analysis unit of the head mounted display system may analyze the visual line of the user for each level specified by the attainment time for the visual line data of the user.

In addition, in the head mounted display system, image data used for displaying an image is moving image data of a video game having a displayed image changed according to an operation signal input by the user, and the analysis unit may analyze the visual line of the user at the time of starting the game.

In addition, the head mounted display system may further include a timer measuring a total time in which the user plays the game, and the analysis unit may analyze the visual line of the user whose total time measured by the timer is a predetermined range time.

In addition, in the head mounted display system, image data used for displaying an image is moving image data of a video game having a displayed image changed according to an operation signal input by the user, an operation acquiring unit acquiring information of execution of a predetermined operation by the user in the game is further included, and the analysis unit may analyze the visual line of the user in a case where the execution of a predetermined operation is acquired by the operation acquiring unit.

In addition, in the head mounted display system, the predetermined operation may be an operation of purchasing a content.

In addition, in the head mounted display system, the image data used for displaying an image is moving image data, an attribute acquiring unit acquiring attributes of the user is further included, the analysis unit may analyze the tendency of viewpoints detected by the detection unit, and the generation unit may generate visualization data including data specified at a viewpoint analyzed by the analysis unit.

In addition, in the head mounted display system, image data used for displaying an image is image data purchased by the user, and the analysis unit may analyze the tendency of viewpoints acquired by the detection unit for each attribute and each price of the image data.

In addition, the generation unit of the head mounted display system may generate data acquired by adding the position of the viewpoint of the user acquired by the detection unit to the image as visualization data.

In addition, in the head mounted display system, image data used for displaying an image is moving image data, and the visualization data may include a time axis display section specifying a relation between the viewpoint of each user in the image data and the time axis of the image data.

In addition, the generation unit of the head mounted display system may generate data acquired by adding a bar graph including a result of the analysis acquired by the analysis unit as the visualization data.

In addition, the head mounted display system may further include an output unit outputting the generated visualization data.

A data displaying method according to the present invention may be a data displaying method including: displaying an image on a display unit; detecting visual line data of users viewing the image displayed on the display unit; and generating visualization data according to the detected visual line data of one or more users.

A data generating program according to the present invention may be a data generating program realizing a display function displaying an image on a display unit, a detection function detecting visual line data of users viewing the image displayed on the display unit, and a generation function generating visualization data according to the detected visual line data of one or more users in a head mounted display system.

A video display system according to the present invention may be a video display system including: a video output unit outputting a video including one or more persons; an audio output unit outputting an audio including a sound corresponding to one or more persons; a lighting unit emitting illumination light including non-visible light toward the anterior ocular segment of the user; an imaging unit capturing an anterior ocular segment image including the anterior ocular segment of the user; a visual line detecting unit detecting the visual line direction of the user by analyzing the anterior ocular segment image; and an audio generating unit specifying a person in a case where one or more persons are present in a video output by the video output unit in the visual line direction of the user detected by the visual line detecting unit and generating audio data such that an output state of a voice output from the audio output unit in correspondence with the specified person is different from an output state of the other voices so as to be identifiable for the user.

In addition, the audio generating unit of the video display system may generate the audio data such that the volume of the sound of the specified person is higher than that of the other voices so as to be identifiable for the user.

In addition, the audio generating unit of the video display system may give an additional function in addition to the setting of the volume of the sound of the specified person to be higher than that of the other voices.

In addition, the video display system may include a video generating unit specifying a person in a case where one or more persons are present in the video output by the video output unit in the visual line direction of the user detected by the visual line detecting unit and changing the display form such that the user can gaze at a video of a predetermined area including at least a part of the specified person more easily than the video of an area other than the predetermined area.

In addition, the video output unit of the video display system may be disposed in a head mounted display worn by the user on the head.

In addition, a video displaying method according to the present invention may be a video displaying method including: outputting a video including one or more persons; outputting an audio including a sound corresponding to one or more persons; emitting illumination light including non-visible light toward the anterior ocular segment of the user; capturing an anterior ocular segment image including the anterior ocular segment of the user; detecting the visual line direction of the user by analyzing the anterior ocular segment image; and specifying a person in a case where one or more persons are present in a video output in the visual line direction of the user detected in the detection of the visual line and generating audio data such that an output state of a voice output in correspondence with the specified person is different from an output state of the other voices so as to be identifiable for the user.

A video displaying program according to the present invention may be a video displaying program realizing: a video output function outputting a video including one or more persons; an audio output function outputting an audio including a sound corresponding to one or more persons; a lighting function emitting illumination light including non-visible light toward the anterior ocular segment of the user; an imaging function capturing an anterior ocular segment image including the anterior ocular segment of the user; a visual line detecting function detecting the visual line direction of the user by analyzing the anterior ocular segment image; and an audio generating function specifying a person in a case where one or more persons are present in an output video in the visual line direction of the user detected by the detection function and generating audio data such that an output state of a voice output in correspondence with the specified person is different from an output state of the other voices so as to be identifiable for the user.

The present invention can be used for a head mounted display.

What is claimed is:

1. An image providing system in which a plurality of head mounted display systems are connected to a server,
the server including:
a first communication control unit transmitting image data to the connected head mounted display systems; and
a generation unit generating new image data according to information relating to visual lines of users transmitted from the head mounted display systems in accordance with the image data and outputting the generated new image data to the first communication control unit, and
each of the head mounted display systems including:
a display unit displaying the image data supplied from the server;
a detection unit detecting a visual line of a user viewing the image data displayed on the display unit; and
a second communication control unit transmitting information relating to the visual line detected by the detection unit to the server.

2. The image providing system according to claim 1,
wherein the generation unit generates image data including information relating to visual lines detected by the plurality of head mounted display systems in the image data, and
wherein the first communication control unit transmits the image data including the visual lines.

3. The image providing system according to claim 1,
wherein at least one of the plurality of head mounted display systems is a host system, and the other head mounted display systems are client systems,
wherein the generation unit generates image data including information relating to visual lines detected by a plurality of the client systems in the image data, and
wherein the first communication control unit transmits the image data including the information relating to the visual lines to the host system.

4. The image providing system according to claim 3,
wherein the host system further includes an input unit receiving an input of a request requesting generation of image data to which information according to a visual line included in the image data is added from a user,
wherein the second communication control unit of the host system transmits a request signal input to the input unit to the server, and
wherein the generation unit generates new image data according to the request signal transmitted from the host system.

5. The image providing system according to claim 2, wherein the generation unit generates new image data by adding only information relating to a visual line detected by a selected head mounted display system among the plurality of head mounted display systems.

6. The image providing system according to claim 3, wherein the generation unit generates new image data by adding only information relating to a visual line detected by a selected head mounted display system among the plurality of head mounted display systems.

7. The image providing system according to claim 4, wherein the generation unit generates new image data by adding only information relating to a visual line detected by a selected head mounted display system among the plurality of head mounted display systems.
